(19) United States
(12) Patent Application Publication
(10) Pub. No.: US 2006/0059018 A1
(43) Pub. Date: Mar. 16, 2006

(54) Medical practice management method, and portable terminal, management server, and medical practice management system using the same

(75) Inventors: Tatsuya Shiobara, Kanagawa (JP); Masafumi Kobayashi, Kanagawa (JP); Norio Kobayashi, Tokyo (JP); Hiroshi Uchida, Kanagawa (JP); Yuji Fukushima, Tokyo (JP); Hiroyuki Araki, Tokyo (JP)

Correspondence Address: Thomas Spinelli;Scully, Scott, Murphy & Presser, Suite 300, 400 Garden City Plaza, Garden City, NY, 11530, US

(73) Assignees: OLYMPUS CORPORATION, TOKYO (JP); OLYMPUS MEDICAL SYSTEMS CORP., TOKYO (JP)

(21) Appl. No.: 11/228,828

(22) Filed: Sep. 16, 2005

(30) Foreign Application Priority Data
Sep. 16, 2004 (JP) 2004-269284
Nov. 26, 2004 (JP) 2004-342909
May 13, 2005 (JP) 2005-141958

(51) Int. Cl. G06Q 10/00

(52) U.S. Cl. 705/2

(57) ABSTRACT

A medical practice management system of the present invention acquires schedule information on a medical practice to be administered to a patient. Information on medical equipment corresponding to the acquired schedule information is selected from among pieces of information on medical equipment to be used in medical practices, stored in association with a plurality of pieces of schedule information, respectively. Then, the acquired schedule information and the selected information on medical equipment are managed in association with each other.

### CROSS-REFERENCE TO RELATED APPLICATIONS

This application is based upon and claims the benefit of priority from the prior Japanese Patent Application No. 2005-141958, filed May 13, 2005, Japanese Patent Application No. 2004-342909, filed Nov. 26, 2004, Japanese Patent Application No. 2004-269284, filed Sep. 16, 2004, the entire contents of which are incorporated herein by reference.

### BACKGROUND OF THE INVENTION

1. Field of the Invention

The invention relates to technologies for medical practice management. In particular, the invention relates to a medical practice management method for managing medical equipment, and a portable terminal, a management server, and a medical practice management system using the same.

2. Description of the Related Art

Medical practices such as a surgical operation and medication involve manual operations, and thus are susceptible to medical errors. For this reason, medical worksites typically make it a rule to double-check by different nurses when drips, injections, and the like are administered to patients. Effecting such a rule, however, can make the operations of the nurses and others even busier. Then, in Japanese Patent Laid-Open Publication No. 2001-344338, identification numbers are granted to patients in advance so that the relation between the identification numbers and medicines to be administered to the patients is databased. The patients are also made to carry their identification numbers by predetermined means. In such a configuration, the nurses use a portable terminal to read the identification numbers possessed by the patients when they administer medicines. The identification numbers are also transmitted to a computer that records the database. The computer consults the database and notifies the nurses of the medicines corresponding to the identification numbers. (Also see Japanese Patent Laid-Open Publication No. 2002-304584.)

Equipment, medicines, and the like necessary to conduct medical practices, or surgical operations in particular, are often prepared empirically by nurses and others. This gives rise to the possibility that improper medicines might be prepared at the time of preparation of necessary equipment, medicines, etc. The greater the number of patients, the more frequent the equipment and the like must be prepared for each individual patient. In general, making preparation from scratch not only imposes higher burdens on the nurses and others, but also increases the chances of errors. In the meantime, given an identical technique, the same equipment, medicines, and the like are likely to be prepared. What is more, medical institutions need revenue and expenditure management. On that account, medical institutions have the need to grasp the costs of equipment, medicines, and the like used in surgical operations.

### SUMMARY OF THE INVENTION

The present invention has been achieved in view of the foregoing circumstances. The present invention provides a medical practice management method for grasping the schedules and track records of medical practices with facility and reliability, and a portable terminal, a management server, and a medical practice management system using the same.

In an embodiment of the present invention, the medical practice management system may comprise: an acquisition unit which acquires schedule information on a medical practice to be administered to a patient; a storing unit which stores a plurality of pieces of information on medical equipment to be used in a medical practice, in association with a plurality of pieces of schedule information, respectively; a selection unit which selects information on medical equipment corresponding to the schedule information acquired by the acquisition unit, from among the plurality of pieces of information on medical equipment stored in the storing unit; and a management unit which manages the acquired schedule information and the information on medical equipment selected by the selection unit in association with each other.

In another embodiment of the present invention, the medical practice management system may comprise: an acquisition unit which acquires administrative information on a medical practice to be administered, the administrative information including at least information on medical equipment to be used and information on a medical practitioner; a storing unit which stores unit prices for a plurality of cost items, respectively, including a cost of the medical equipment and a labor cost of the medical practitioner; and a calculation unit which calculates costs for a single medical practice with reference to the administrative information and the unit prices. Here, “a single medical practice” may conceptually include a single intervention, or a single unit of surgical operation, and a single inspection.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic diagram for explaining the channels of distribution of medical equipment in a medical equipment distribution system according to embodiment 1 of the present invention;

FIG. 2 is a diagram showing the configuration of a medical practice management system according to embodiment 1 of the present invention;

FIG. 3 is a flowchart showing the operation procedure on which the embodiment 1 of the present invention is predicated;

FIG. 4 is a flowchart showing the processing procedure of the closing date for an operation order of FIG. 3;

FIG. 5 is a flowchart showing the processing procedure of the day before the operation of FIG. 3;

FIG. 6 is a flowchart showing the processing procedure of the day of the operation of FIG. 3;

FIG. 7 is a diagram showing the configuration of the medical practice management system according to embodiment 1 of the present invention;

FIG. 8 is a diagram showing a screen for order registration, which appears on the display unit of FIG. 7;

FIG. 9A is a chart showing the structure of data in the database of FIG. 7, or the correspondence between techniques and medical equipment in particular;

FIG. 9B is a chart showing the structure of data in the database of FIG. 7, or the relation among medical equipment, identification numbers assigned to the medical equipment, and the costs of the medical equipment in particular;

FIG. 10 is a chart showing the structure of data recorded in the management unit of FIG. 7;

FIG. 11 is a diagram showing a screen for listing administration entries, which appears on one of the display units of FIG. 7;

FIG. 12 is a diagram showing a screen for administration entry, which appears on the display unit of FIG. 7;

FIG. 13 is a diagram showing a screen for checking set items, which appears on the display unit of FIG. 7;

FIG. 14 is a diagram showing a screen for listing medical equipment, which appears on the display unit of FIG. 7;

FIG. 15 is a diagram showing a screen for order details, which appears on the display unit of FIG. 7;

FIG. 16 is a diagram showing a screen for administration entry, which appears on the other display unit of FIG. 7;

FIG. 17 is a flowchart showing the procedure for making a reservation by the medical institution computer of FIG. 7;

FIG. 18 is a sequence diagram showing the procedure by which the medical practice management system of FIG. 7 registers administrative contents;

FIG. 19 is a flowchart showing the procedure by which the portable terminal of FIG. 7 registered administrative contents;

FIG. 20 is a flowchart showing the procedure by which the medical institution computer of FIG. 7 registers administrative contents;

FIG. 21 is a diagram showing a screen for a preparation item list, which appears on a display unit according to a modification of embodiment 1;

FIG. 22 is a diagram showing another screen for a preparation item list, which appears on the display unit according to the modification of embodiment 1;

FIG. 23 is a diagram showing still another screen for a preparation item list, which appears on the display unit according to the modification of embodiment 1;

FIG. 24A is a chart showing the configuration of the identification number, or code types in particular, according to another modification of embodiment 1;

FIG. 24B is a chart showing the configuration of the identification number, or concrete examples of the identification number in particular, according to the modification of embodiment 1;

FIG. 25 is a diagram showing a screen for a preparation item list, which appears on the display unit according to another modification of embodiment 1 when clicked;

FIG. 26 is a diagram showing a screen for changing the quantities of preparation items, which appears on the display unit according to the modification of embodiment 1;

FIG. 27 is a diagram showing a screen for checking the details of the preparation item list, which appears on the display unit according to the modification of embodiment 1;

FIG. 28 is a diagram showing a screen for adding preparation items, which appears on the display unit according to the modification of embodiment 1;

FIG. 29 is a diagram showing another screen for adding preparation items, which appears on the display unit according to the modification of embodiment 1;

FIG. 30 is a diagram showing a first configuration of the medical practice management system according to embodiment 2 of the present invention;

FIG. 31 is a diagram showing the details of the database in FIG. 30;

FIG. 32 is a diagram showing a second configuration of the medical practice management system according to embodiment 2 of the present invention;

FIG. 33 is a diagram showing a screen on which the relation between the material costs and concurrent diseases is displayed graphically, which appears on the display unit of FIG. 30 or 32;

FIG. 34 is a flowchart showing the procedure by which the medical practice management system of FIG. 30 or 32 calculates costs for each single medical practice; and

FIG. 35 is a flowchart showing the procedure by which the medical practice management system of FIG. 30 or 32 calculates monetary valuations of reusable products.

### DETAILED DESCRIPTION OF THE INVENTION

### Embodiment 1

The present invention will now be overviewed before described in detail. Embodiment 1 of the present invention relates to a medical practice management system for managing schedules for medical practices, such as a surgical operation, and administrative contents of the same. The medical practice management system is used in the stage of scheduling operations and in the stage of registering administrative contents of the operations. In the medical practice management system according to the present embodiment, medical practitioners such as a doctor and a nurse enter operation schedules into a computer (hereinafter, the entered information on operation schedules will be referred to as “schedule information”). Here, techniques are specified by selecting at least one from among a plurality of predetermined techniques. There are stored a plurality of combinations of information on medical equipment, concerning equipment, medicines, and the like to be used in medical practices, and techniques. The information on medical equipment is selected depending on the technique(s) selected by the medical practitioner. The medical practice management system manages the schedule information and the information on medical equipment in combination.

In the stage where administrative contents of an operation are registered, identification numbers are labeled on respective pieces of medical equipment. Here, the identification numbers are expressed in the form of text, numerals, graphics, or the like. Medical practitioners read the identification numbers of the medical equipment to be used in the operation by using a device capable of recognizing the identification numbers, such as a portable terminal having scanner facilities. The read identification numbers are transmitted to the computer, and incorporated into the foregoing schedule information for management. Since the schedules and administrative contents of operations are thus integrated with each other, some of the data included in the schedules can be used intact as data to be included in the administrative contents. This makes it easy to manage the administrative contents. Data on the costs of the medical equipment is also stored in advance, so that the costs for the used medical equipment are also calculated. Moreover, track records of the used medical equipment are reflected on the information on medical equipment. This improves the precision of selection of medical equipment when schedule information is entered the next time.

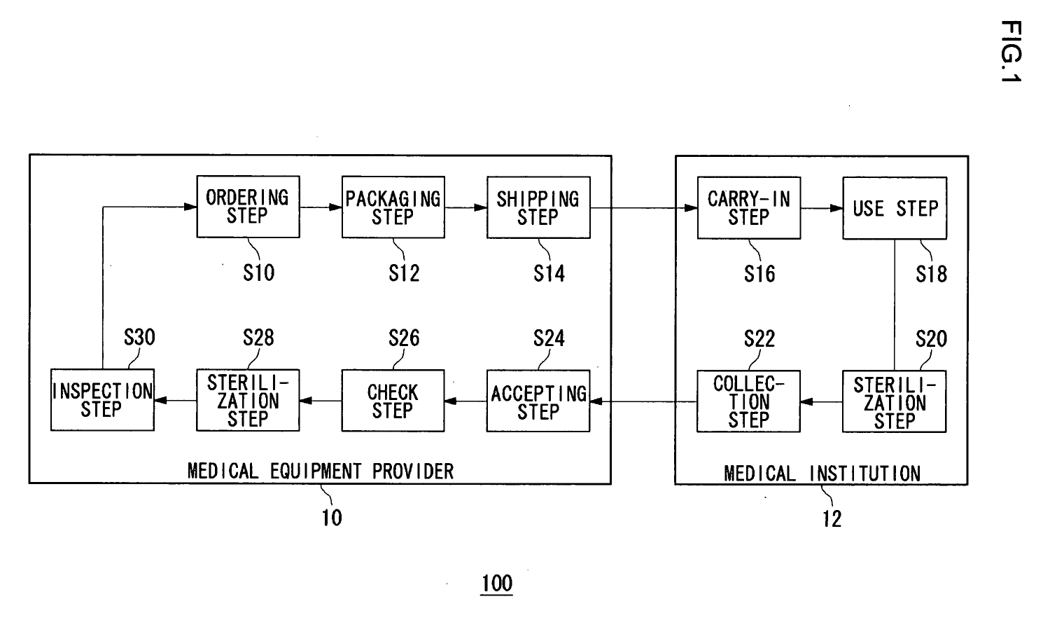

Before discussing a medical practice management system according to the embodiment of the present invention, description will first be given of a medical equipment distribution system 100 in which the medical equipment management system is used. FIG. 1 is a schematic diagram for explaining the distribution channels of medical equipment in the system 100 for distributing medical equipment according to embodiment 1 of the present invention. The medical equipment distribution system 100 includes a medical equipment provider 10 and a medical institution 12. Here, the channels of distribution shown between the medical equipment provider 10 and the medical institution 12 are only those for transporting medical equipment. In fact, the channels of distribution lying between the medical equipment provider 10 and the medical institution 12 also include a network, such as the Internet, for placing and receiving orders for medical equipment. For ease of explanation, the diagram shows the medical equipment distribution system 100 as if it consists of a single medical equipment provider 10 and a single medical institution 12. The entire medical equipment distribution system 100 typically includes, however, a plurality of medical institutions 12.

The medical equipment provider 10 is an institution for providing medical equipment, and corresponds to a medical equipment maker, for example. The medical institution 12 is the user of the medical equipment, and typically corresponds to a hospital. The medical equipment provider 10 receives orders for medical equipment from the medical institution over the not-shown network (S10). The medical equipment provider 10 packages the medical equipment according to the order received (S12). Then, the medical equipment provider 10 ships the packaged medical equipment to the medical institution 12 (S14).

The medical equipment shipped from the medical equipment provider 10 is carried into the medical institution 12 (S16). The medical institution 12 uses the carried-in medical equipment for an operation (S18). Each part constituting the medical equipment is used in the operation.

After use, the medical equipment is disassembled into parts. Of the disassembled parts, ones included in a portion of medical equipment to be returned to the medical equipment provider 10 (hereinafter, referred to as “returnable medical equipment”) are washed and then subjected to sterilization processing (S20). The sterilized medical equipment may be used again for operations, whereas description thereof will be omitted here for ease of explanation. This washed and sterilized returnable medical equipment, in the form of disassembled parts, is collected by the medical equipment provider 10 (S22) and accepted by the medical equipment provider 10 (S24).

The medical equipment provider 10 checks if the returnable medical equipment collected is to be collected (S26). That is, it checks if anything is missing in the returnable medical equipment collected, or if the returnable medical equipment collected includes any unnecessary piece. The medical equipment provider 10 sterilizes the collected returnable medical equipment again (S28). In the returnable medical equipment sterilized, pieces to be used again are inspected to see whether they are reusable or must be disposed, depending on the status of use of the parts (S30). The pieces of medical equipment determined to be disposed by the inspection are disposed. Such medical equipment is typically collected by a medical waste disposer or an industrial waste disposer. The pieces of medical equipment determined to be reusable are packaged again at step 12.

In the foregoing configuration, the medical practice management system according to the embodiment of the present invention is used at step 18. More specifically, the medical practice management system manages schedules for operations (hereinafter, such a phase will be referred to as “scheduling phase”), and manages the administrative contents of the operations (hereinafter, such a phase will be referred to as “administrative phase”). In the scheduling phase, the medical practice management system exercises management so that medical equipment necessary for operations is provided. Meanwhile, in the administrative phase, the medical practice management system calculates the costs of the medical equipment used for operations and manages to clarify the stock of the medical equipment.

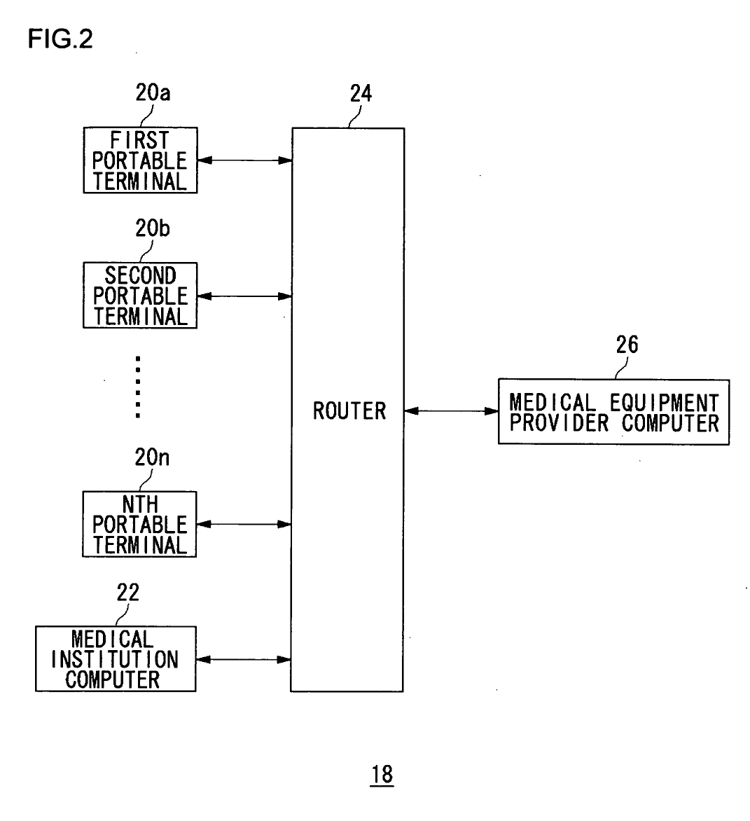

FIG. 2 shows the configuration of the medical practice management system 18 according to embodiment 1 of the present invention. The medical practice system 18 includes a first portable terminal 20a, a second portable terminal 20b, an nth portable terminal 20n, a medical institution computer 22, a router 24, and a medical equipment provider computer 26. The first to nth portable terminals 20n will be referred to collectively as portable terminals 20.

The portable terminals 20 have scanner facilities for reading identification numbers given to medical equipment, and input and output predetermined information. Personal digital assistants (PDAs) may be used, for example. The portable terminals 20 are used by medical practitioners in the medical institution 12.

The medical institution computer 22 manages the schedule information, the information on medical equipment, and the information on administrative contents in the scheduling phase and the administrative phase. Like the portable terminals 20, the medical institution computer 22 is also arranged in the medical institution 12. The medical practitioners use the medical institution computer 22 directly to make the medical institution computer 22 manage the foregoing information. Moreover, the portable terminals 20 may be used to make the medical institution computer 22 manage the foregoing information. For that purpose, the portable terminals 20 and the medical institution computer 22 are connected over a network such as a wireless LAN (local area network). For example, the medical institution computer 22 is installed in a nurse station, and the portable terminals 20 are carried by the medical practitioners. As a result, the medical practitioners can use the portable terminals 20 to access the medical institution computer 22 even from locations other than the nurse station.

The medical equipment provider computer 26 is one that is installed in the medical equipment provider 10, and manages information such as the information on medical equipment shipped to the medical institution 12. The medical equipment provider computer 26 may also manage part or all of the information to be managed by the medical institution computer 22. For that purpose, the portable terminals 20 and the medical institution computer 22 are connected with the medical equipment provider computer 26 over a network. Incidentally, the network is typically divided by the router 24 since the two parties belong to respective different businesses.

For ease of explanation, the following description will deal with the case where the schedule information, the information on medical equipment, and the information on administrative contents in the scheduling phase and the administrative phase are managed by the medical institution computer 22. As mentioned previously, these pieces of information may be managed by the medical equipment provider computer 26. In that case, the contents stored in the storage media of the medical equipment provider computer 26 and the contents stored in the storage media of the medical institution computer 22 may be synchronized with each other.

Next, description will be given of the situation where the medical practice management system 18 is used in step 18 of FIG. 1, e.g., for a surgical operation. A surgical operation includes a plurality of steps, in part of which the medical practice management system 18 is used. Description will thus be given of that part.

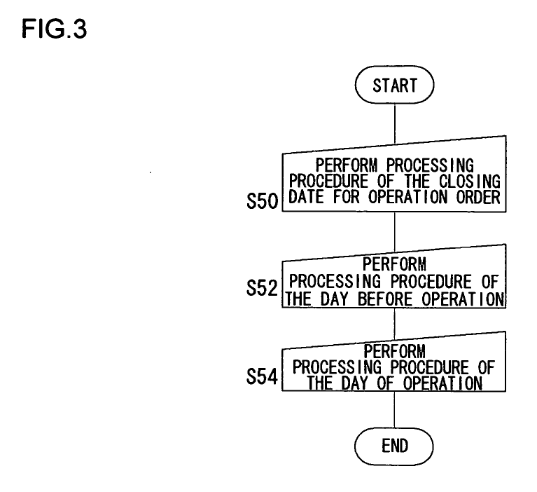

FIG. 3 is a flowchart showing the operation procedure on which the embodiment 1 of the present invention is predicated. In the medical institution 12, a medical practitioner performs the processing procedure of the closing date for an operation order (S50). This processing is performed several days before the operation, and is equivalent to making reservations for an operating room and medical equipment necessary for the operation. The medical practitioner also performs the processing procedure of the day before the operation (S52). This corresponds to preparation to be made on the day before the operation. Moreover, the medical practitioner performs the processing procedure of the day of the operation (S54). This includes preparation immediately before the operation and treatments after the operation, as well as the operation itself. Here, steps 50 and 52 correspond to the scheduling phase, and step 54 the administrative phase. The medical practice management system 18 is used in each of the foregoing steps. Hereinafter, these steps will be described in detail.

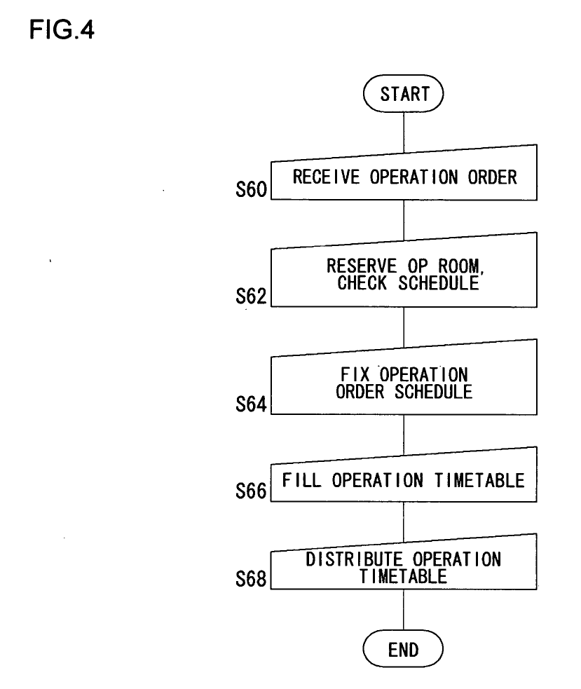

FIG. 4 is a flowchart showing the processing procedure of the closing date for an operation order. This shows the detailed process of step 50 in FIG. 3. The medical practitioner receives an operation order from a medical office in charge of the operation (S60). The medical practitioner reserves an operating room and checks the schedule (S62). Because of this, the medical practitioner fixes the operation order (S64). Subsequently, the medical practitioner uses the medical institution computer 22 to fill an operation timetable (S66). The operation timetable is then distributed to medical practitioners and the like who are involved (S68). In the foregoing procedure, the medical practice management system 18 is used at step 66.

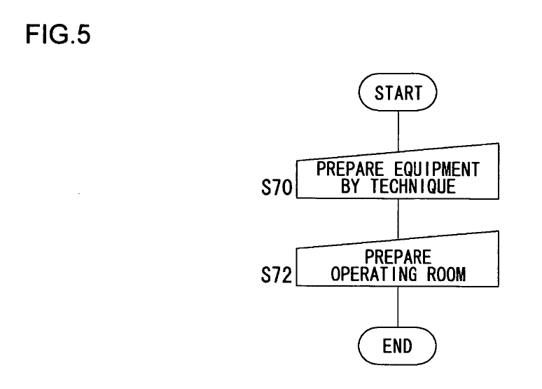

FIG. 5 is a flowchart showing the processing procedure of the day before the operation. This shows the detailed process of step 52 in FIG. 3. The medical practitioner prepares equipment by technique (S70). Here, the medical practitioner uses his/her portable terminal 20 to browse the operation timetable which is filled at step 66 of FIG. 4 and is stored in the medical practice computer 22. The medical practitioner also checks the operation timetable for the entered medical equipment while preparing the equipment. Subsequently, the medical practitioner prepares the operating room (S72). In the foregoing procedure, the medical practice management system 18 is used at step S70.

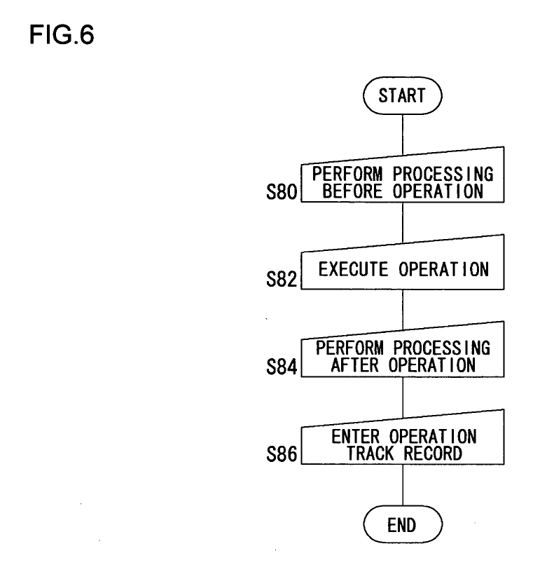

FIG. 6 is a flowchart showing the processing procedure of the day of the operation. This shows the detailed process of step 54 in FIG. 3. The medical practitioner performs processing before the operation (S80). The medical practitioner uses his/her portable terminal 20 to read the identification numbers given to the medical equipment used actually in the operation. Incidentally, this processing may be performed in the operation step to be described later. Moreover, the medical practitioner executes the operation (S82), and performs processing after the operation (S84). The medical practitioner also enters the track record of the operation, such as the time taken to execute the operation, into the portable terminal 20 or the medical institution computer 22 (S86). In the foregoing procedure, the medical practice management system 18 is used at steps 80 and 86. Incidentally, as mentioned previously, the medical practice management system 18 may also be used at steps 82 and 84, as well as at step 80.

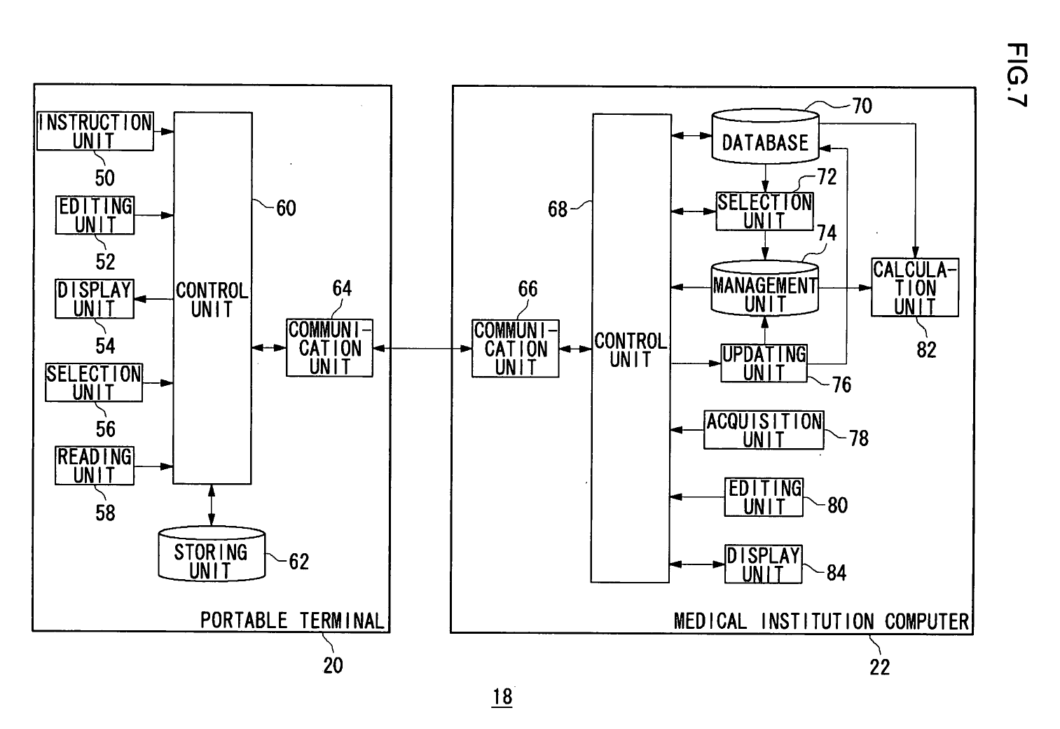

FIG. 7 is a diagram showing the configuration of the medical practice management system 18 according to embodiment 1 of the present invention. As mentioned previously, the medical practice management system 18 includes the portable terminal 20 and the medical institution computer 22. The portable terminal 20 has an instruction unit 50, an editing unit 52, a display unit 54, a selection unit 56, a reading unit 58, a control unit 60, a storing unit 62, and a communication unit 64. The medical institution computer 22 includes a communication unit 66, a control unit 68, a database 70, a selection unit 72, a management unit 74, an updating unit 76, an acquisition unit 78, an editing unit 80, a calculation unit 82, and a display unit 84. Hereinafter, the components to be used in the scheduling phase and those in the administrative phase will be described separately.

Initially, description will be given of the scheduling phase. The acquisition unit 78 acquires schedule information on a medical practice, such as a surgical operation, to be administered to a patient. Here, the schedule information refers to information that must be determined beforehand in order to administer an operation. For example, the schedule information includes the name of the patient, the operating room, the start time of the operation, the operator, and the technique. Here, the medical practitioner enters items displayed on the display unit 84, i.e., fills the items that appear on the display unit 84. In the meantime, the display unit 84 displays a plurality of pieces of schedule information, or a list of alternatives, for a single item. For example, techniques previously stored in the database 70 to be described later, such as “laparoscopic cholecystectomy” and “transurethral coagulation,” are displayed in a list view for “technique.” The acquisition unit 78 acquires the schedule information by having the medical practitioner select from among a list of alternatives displayed on the display unit 84.

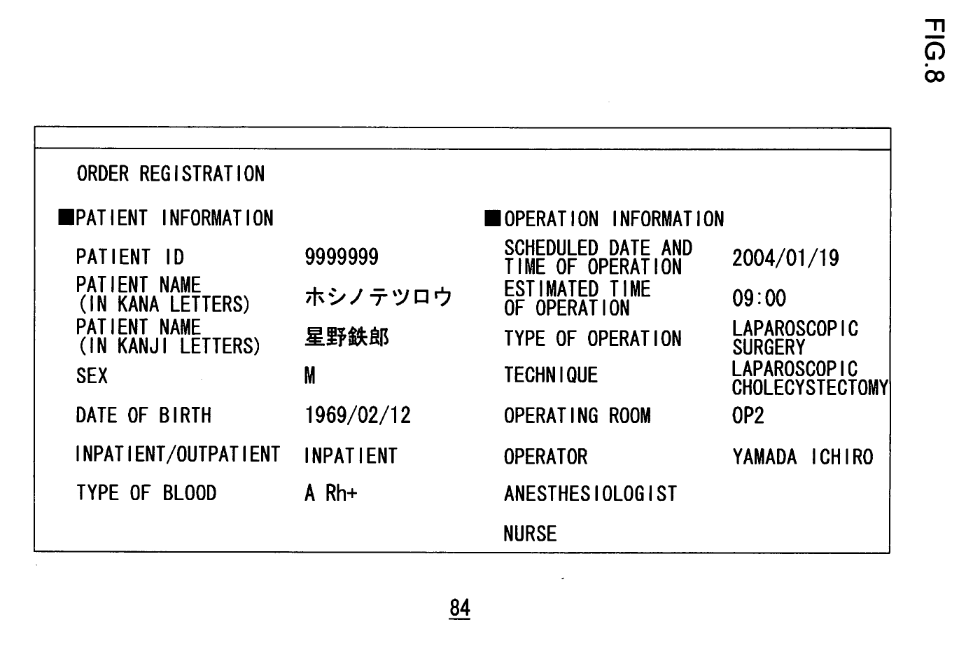

FIG. 8 shows a screen for order registration, which appears on the display unit 84. On the screen shown in FIG. 8, such items as “Patient ID,” “Patient Name (in Kana Letters),” “Scheduled Date and Time of Operation,” and “Estimated Time of Operation” are to be filled by the medical practitioner. The corresponding pieces of information constitute the schedule information. Incidentally, FIG. 8 shows the case where all the items are not filled out. When the medical practitioner moves the pointer to “Technique” in the diagram, for example, a list of techniques is displayed in a pop-up fashion. The medical practitioner selects one from among the techniques popped up. Incidentally, items other than “Technique” may also be selected in this way.

Return now to FIG. 7. The database 70 stores a plurality of pieces of information on medical equipment to be used in medical practices in association with a plurality of pieces of schedule information, respectively. That is, one single technique is combined with the information on the medical equipment to be used in this technique. Depending on the number of techniques, a plurality of combinations are stored. For example, the database 70 contains the combination of “laparoscopic cholecystectomy” and information on the corresponding medical equipment, and the combination of “transurethral coagulation” and information on the corresponding medical equipment.

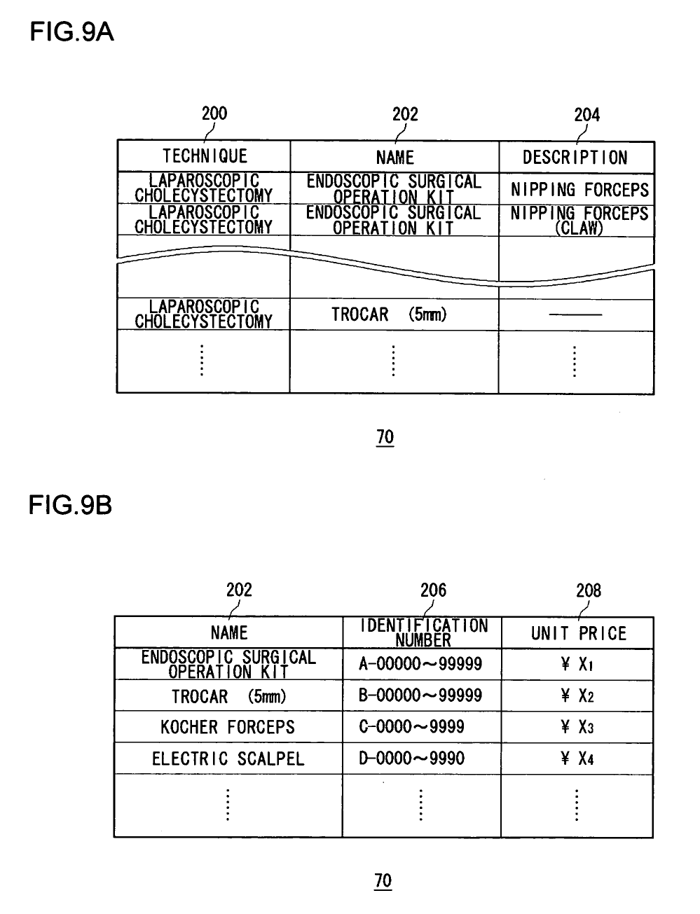

FIGS. 9A and 9B show the structure of data in the database 70. FIG. 9A shows the correspondence between techniques and medical equipment. As shown in the chart, there are provided a technique field 200, a name field 202, and a description field 204, each containing predetermined information. The information entered in the technique field 200 corresponds to the information on technique. The information entered in the name field 202 and the description field 204 corresponds to the information on medical equipment. Here, if medical equipment entered in the name field 200 is composed of a plurality of parts, the names of the parts are described in the description field 204. FIG. 9B shows the relation among the medical equipment, the identification numbers given to the medical equipment, and the costs of the medical equipment. The name field 202, an identification number field 206, and a unit price field 208 in the chart correspond to the medical equipment, the identification numbers given to the medical equipment, and the costs of the medical equipment, respectively. The identification numbers are ones assigned to actual pieces of medical equipment, and are used to grasp the pieces of medical equipment used actually in the administrative phase to be described later. Such identification numbers are labeled on the medical equipment.

Return now to FIG. 7. The selection unit 72 selects information on medical equipment corresponding to the schedule information acquired by the acquisition unit 78, from among the plurality of pieces of information on medical equipment stored in the database 70. That is, when a “technique” of “laparoscopic cholecystectomy” is entered to the acquisition unit 78, the selection unit 72 selects the medical equipment shown in the name field 202 and the description field 204 corresponding to the technique field 200 having the entry of “laparoscopic cholecystectomy.” For example, an “endoscopic surgical operation kit” or the like is selected.

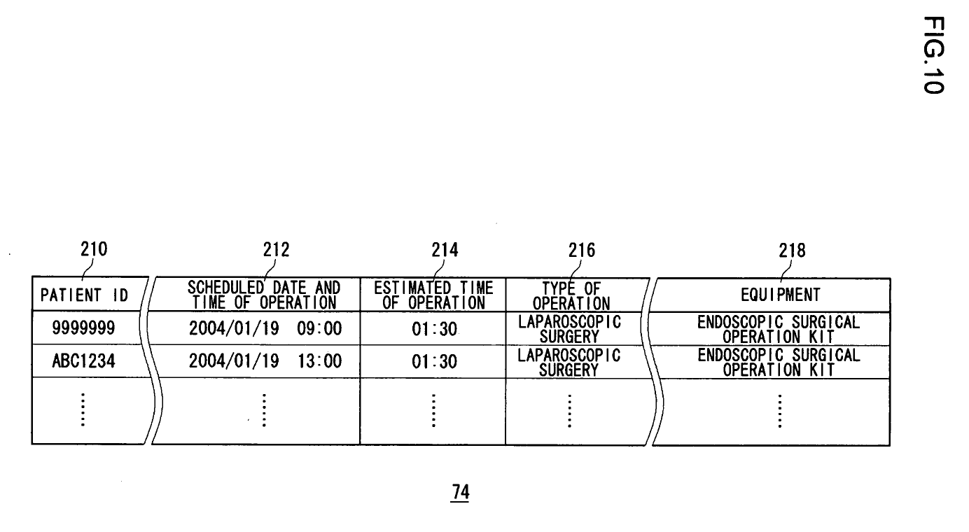

The management unit 74 manages the acquired schedule information and the information on medical equipment selected by the selection unit 72 in association with each other. Specifically, the schedule information and such information as “endoscopic surgical operation kit” are managed integrally. FIG. 10 shows the structure of data recorded in the management unit 74. As shown in the chart, there are provided a “Patient ID” field 210, a “Scheduled Date and Time of Operation” field 212, an “Estimated Time of Operation” field 214, a “Type of Operation” field 216, and an “Equipment” field 218. The “schedule information” is recorded in the fields ranging from the “Patient ID” field 210 to the “Type of Operation” field 216. The “information on medical equipment” is recorded in the “Equipment” field 218. In FIG. 10, each single row shows the information corresponds to the combination of the “schedule information” and the “information on medical equipment” for a single patient. Incidentally, the “schedule information” and the “information on medical equipment” are not limited to those of FIG. 10.

Return now to FIG. 7. The medical practitioner edits at least any of the schedule information and the information on medical equipment managed in the management unit 74 via the editing unit 80. More specifically, take, for example, the case of modifying “scheduled date and time of operation” in the schedule information registered in advance. The medical practitioner makes the display unit 84 display the information managed in the management unit 74, and makes predetermined modifications from the editing unit 80 based on the screen display. Incidentally, the control unit 68 controls the input and output of information and the timing thereof so that the medical institution computer 22 can perform predetermined processing. When the schedule information is fixed in the scheduling phase, a list of medical equipment to be prepared is simultaneously displayed on the display unit 84 as a preparation item list, for example. Here, the control unit 68 prompts to change the quantities of medical equipment shown on the preparation item list, delete some, or add new equipment to the preparation item list. When a change, addition, or deletion is made, it is notified to the management unit 74 to update the data in the database 70. Moreover, when an order registration described in step S52 is conducted, the control unit 68 prompts to print the preparation item list. When an instruction to print the preparation item list is issued, the preparation item list is printed by a not-shown printer. When a plurality of medical practices are scheduled or a plurality of techniques are included in a single schedule, all the preparation items in association with the corresponding medical practice(s) may be displayed in a list view.

Now, description will be given of the administrative phase. To perform the processing of the administrative phase, the instruction unit 50 instructs the management unit 74 to output a list of schedule information. This output instruction is transmitted to the management unit 74 via the communication units 64 and 66. As described previously, the management unit 74 contains a plurality of combinations of schedule information and information on medical equipment in association with each other. These pieces of information are output in response to the instruction from the instruction unit 50. The communication unit 64 receives the associated combinations of schedule information and information on medical equipment from the management unit 74.

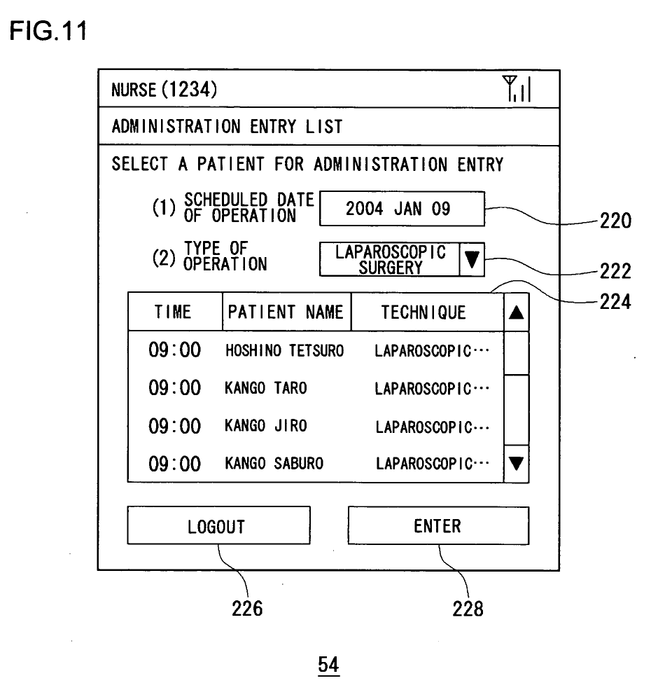

The display unit 54 displays the list of schedule information which is input from the management unit 74. FIG. 11 shows a screen for listing administration entries, which appears on the display unit 54. As shown in FIG. 11, the screen has a “Scheduled Date of Operation” window 220, a “Type of Operation” window 222, a description window 224, a “Logout” button 226, and an “Enter” button 228. When the medical practitioner enters predetermined information into the “Scheduled Date of Operation” window 220 and the “Type of Operation” window 222, corresponding pieces of schedule information input from the management unit 74 appear in the description window 224. Specifically, the schedule information concerning a predetermined scheduled date of operation and a predetermined type of operation appears in the description window 224.

On the list of schedule information displayed in the description window 224, the medical practitioner specifies the schedule information corresponding to the medical practice going to be administered. This is equivalent to making selection of the schedule information. This processing corresponds to the processing of the selection unit 56 in FIG. 7. That is, the selection unit 56 makes the medical practitioner select any one of the plurality of pieces of schedule information displayed on the display unit 54, thereby selecting the schedule information corresponding to the medical practice going to be administered. Incidentally, the specification of the schedule information by the medical practitioner is effected by the medical practitioner selecting any one of the plurality of pieces of schedule information displayed in the description window 224 and then pressing the “Enter” button 228. In FIG. 7, the selection instruction from the selection unit 56 is output to the updating unit 76.

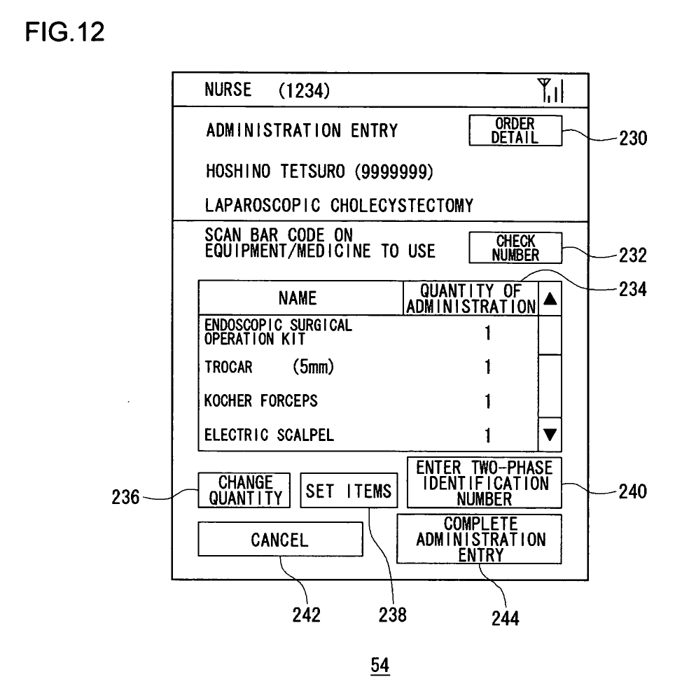

The reading unit 58 reads, from exterior, the identification numbers assigned to the medical equipment to be used actually in the medical practice going to be administered. FIG. 12 shows a screen for administration entry, which appears on the display unit 54. Here, the display shown on the display unit 54 is for situations where the reading unit 58 is performing the read processing. As shown in the diagram, the screen has an “Order Detail” button 230, a “Check Number” button 232, a description window 234, a “Change Quantity” button 236, a “Set Items” button 238, an “Enter Two-stage Identification Number” button 240, a “Cancel” button 242, and a “Complete Administration Entry” button 244. In an initial state where no identification number is read, nothing appears in the description window 234. When the medical practitioner reads identification numbers by using the reading unit 58, the names of the medical equipment corresponding to the identification numbers are displayed. Here, the reading unit 58 consults the database 70 for the relation between the identification numbers and the medical equipment. More specifically, the reading unit 58 refers to the relation between the name field 202 and the identification number field 206 in FIG. 9B.

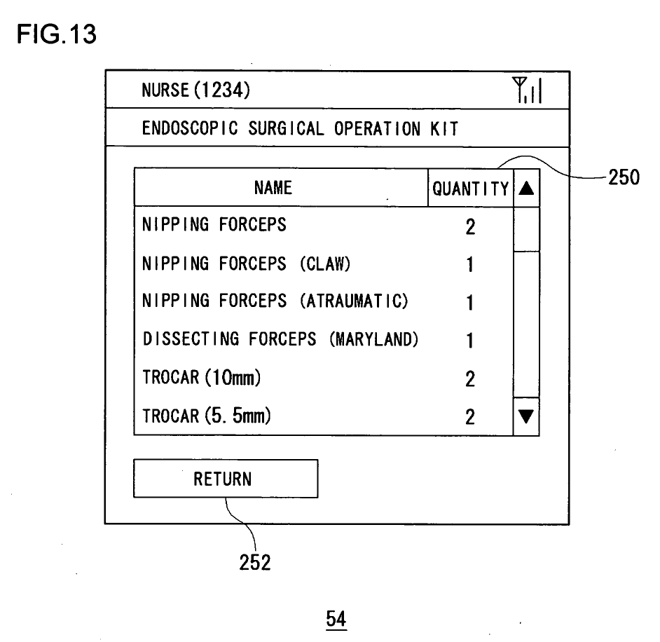

Among the medical equipment displayed in the description window 234, the “endoscopic surgical operation kit” further includes a plurality of pieces of medical equipment. This corresponds to the relation between the name field 202 and the description field 204 in FIG. 9A. In such cases, the medical practitioner can press the “Set Items” button 238 to switch the display on the display unit 54 into FIG. 13. FIG. 13 shows a screen for checking set items, which appears on the display unit 54. As shown in the diagram, the screen has a description window 250 and a return button 252. The description window 250 shows the details of the medical equipment included in the “endoscopic surgical operation kit.” The details of the medical equipment correspond to the items described in the description field 204 of FIG. 9A. The return button 252 is pressed to return to the display of FIG. 12.

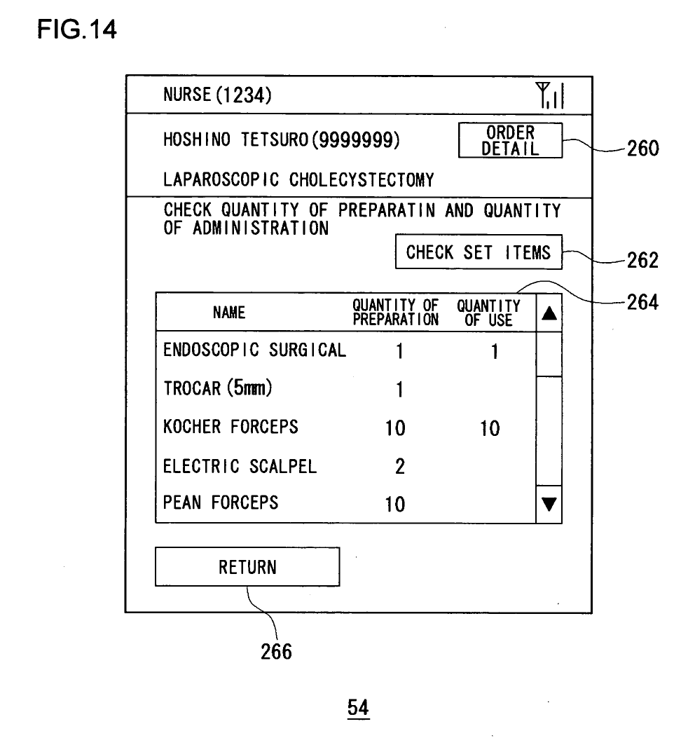

When the medical practitioner presses the “Check Number” button 232 of FIG. 12, the display on the display unit 54 is switched into FIG. 14. FIG. 14 shows a screen for a medical equipment list, which appears on the display unit 54. As shown in the diagram, the screen has an “Order Detail” button 260, a “Check Set Items” button 262, a description window 264, and a “Return” button 266. The description window 264 shows the information on medical equipment corresponding to the schedule information selected by the selection unit 56. This information is not the information that is read by the reading unit 58, but the information that is managed in the management unit 74. This makes it possible for the medical practitioner to browse this information even before the processing of the reading unit 58 is performed. In executing the processing of step 70 in FIG. 5, the medical practitioner makes the screen of FIG. 14 appear on the display unit 54 of the portable terminal 20 and prepares the medical equipment necessary for the operation.

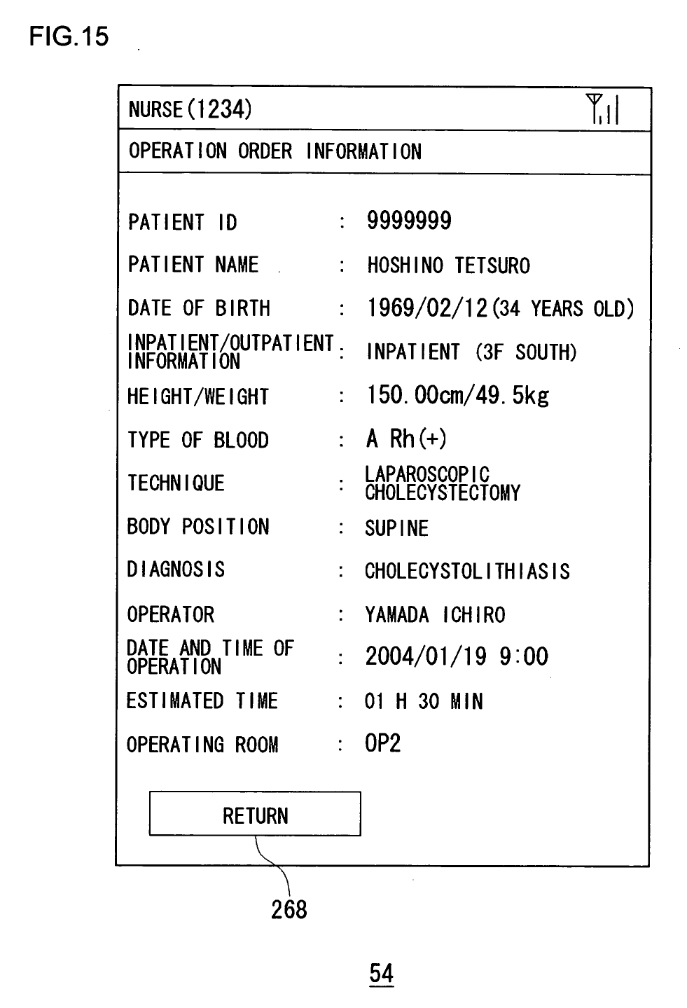

The “Check Set Items” button 262 and the “Return” button 266 have the same functions as those of the “Set Items” button 238 in FIG. 12 and the “Return” button 252 in FIG. 13. When the medical practitioner presses the “Order Detail” button 260, the display on the display unit 54 is switched into FIG. 15. FIG. 15 shows a screen for order detail, which appears on the display unit 54. This screen shows the schedule information that is managed in the management unit 74. Incidentally, the “Order Detail” button 230 in FIG. 12 may also be pressed to switch into this screen.

Return now to FIG. 7. The reading unit 58 associates the information on medical equipment corresponding to the schedule information selected by the selection unit 56 with the read identification numbers, and transmits the resultant to the updating unit 76. The control unit 60 controls the input and output of the information and the timing thereof so that the portable terminal 20 can perform predetermined processing. The storing unit 62 stores the information input to the portable terminal 20, and outputs the stored information from the portable terminal 20 to the medical institution computer 22. Specifically, the portable terminal 20 may access the storing unit 62 to perform the foregoing processing of the portable terminal 20, instead of the medical institution computer 22.

The updating unit 76 associates the information on medical equipment corresponding to the schedule information selected by the selection unit 56, out of the plurality of combinations stored in the management unit 74, with the identification numbers read by the reading unit 58. Then, the updating unit 76 updates the combinations stored in the management unit 74. That is, the updating unit 76 puts identification numbers to the combinations having the data structure shown in FIG. 10. Through such processing, the schedule information, the information on medical equipment, and the information on actually-used medical equipment are managed integrally.

The information stored in the database 70 is further utilized to identify medical equipment from identification numbers. Comparing this medical equipment and the medical equipment stored in the management unit 74 clarifies the difference between the information on medical equipment provided in the database 70 in advance and the medical equipment used in actual operations. Based on this difference, the updating unit 76 updates the information on medical equipment stored in the database 70. Take, for example, the case where the information on medical equipment stored in the database 70 includes “forceps” while no “forceps” was used in an actual operation. In this case, the updating unit 76 deletes the “forceps” from the information on medical equipment stored in the database 70. Incidentally, the foregoing processing is performed in units of each “technique.” More specifically, assuming that the target technique is the “laparoscopic cholecystectomy,” the updating unit 76 updates the information on medical equipment corresponding to the “laparoscopic cholecystectomy” out of the information on medical equipment stored in the database 70. Based on the information on medical equipment accumulated in the management unit 74 technique by technique, the control unit 68 may delete corresponding pieces of medical equipment pertaining to a predetermined technique from the information on medical equipment stored in the database 70. This updating may be conducted when in the following case: that is, when the corresponding information on medical equipment in the database 70 shows that some of the medical equipment do not reach predetermined numbers of uses.

The calculation unit 82 adds up the costs of the medical equipment used in actual medical practices, with reference to the information on the costs of the medical equipment stored in the database 70. Since the database 70 has the data structure as shown in FIG. 9B, the calculation unit 82 identifies the medical equipment and the costs of the medical equipment corresponding to the identification number read by the reading unit 58, with reference to the identification number field 206. Moreover, if a plurality of identification numbers are read by the reading unit 58, they are also subjected to the same processing to identify a plurality of unit prices. The calculation unit 82 eventually adds up the plurality of unit prices.

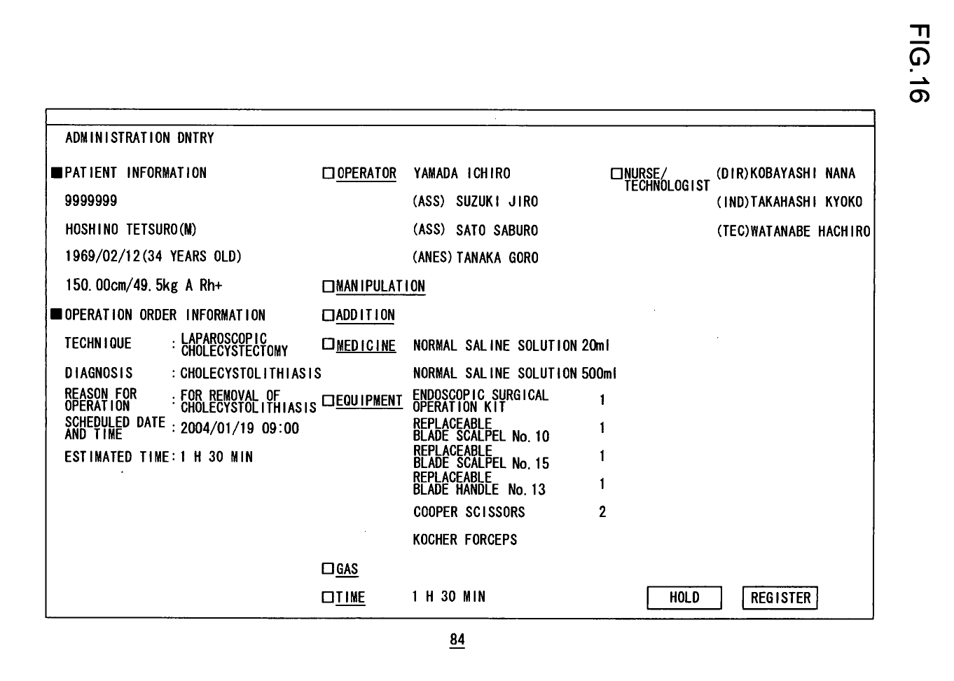

The medical practitioner edits the information on medical equipment stored in the management unit 74 via the editing unit 80 described above. FIG. 16 shows a screen for administration entry, which appears on the display unit 84. The medical practitioner edits the contents on the screen displayed as in FIG. 16. That is, the information shown on the screen of FIG. 16, such as “Time,” are initialized to the information values entered in the scheduling phase. Thus, if the estimated time of operation is “1 h 30 min” and the actual operation takes “1 hour,” the time is corrected from the editing unit 80. Incidentally, such editing may be performed from the editing unit 52.

In terms of hardware, this configuration can be achieved by an arbitrary computer CPU, a memory, and other LSIs. In terms of software, it can be achieved by a program which is loaded on a memory. The functional blocks shown here are realized by the cooperation of these. It will thus be understood by those skilled in the art that these functional blocks may be achieved in various forms including hardware alone, software alone, and a combination of these.

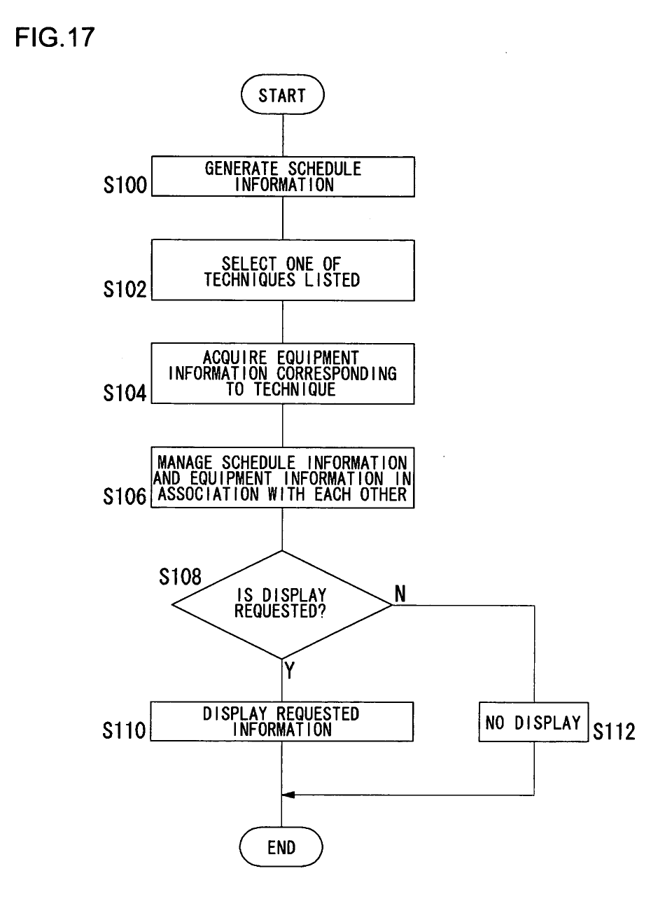

Description will now be given of the operation of the medical practice management system 18 having the foregoing configuration. FIG. 17 is a flowchart showing the procedure for making a reservation by the medical institution computer 22. The acquisition unit 78 generates schedule information while receiving instructions from the medical practitioner (S100). The display unit 54 shows the screen of FIG. 8. Here, the medical practitioner selects at least one of techniques listed (S102). The acquisition unit 78 inputs the selected technique into schedule information. The selection unit 72 acquires the information on medical equipment corresponding to the technique from among the plurality of pieces of information on medical equipment stored in the database 70 (S104). The management unit 74 manages the schedule information and the information on medical equipment in association with each other (S106). When a display request is issued by the medical practitioner (Y at S108), the display unit 84 displays the information managed in the management unit 74 (S110). Here, the display unit 54 shows the screen of FIG. 16. On the other hand, if no request is issued (N at S108), the display unit 84 makes no display (S112).

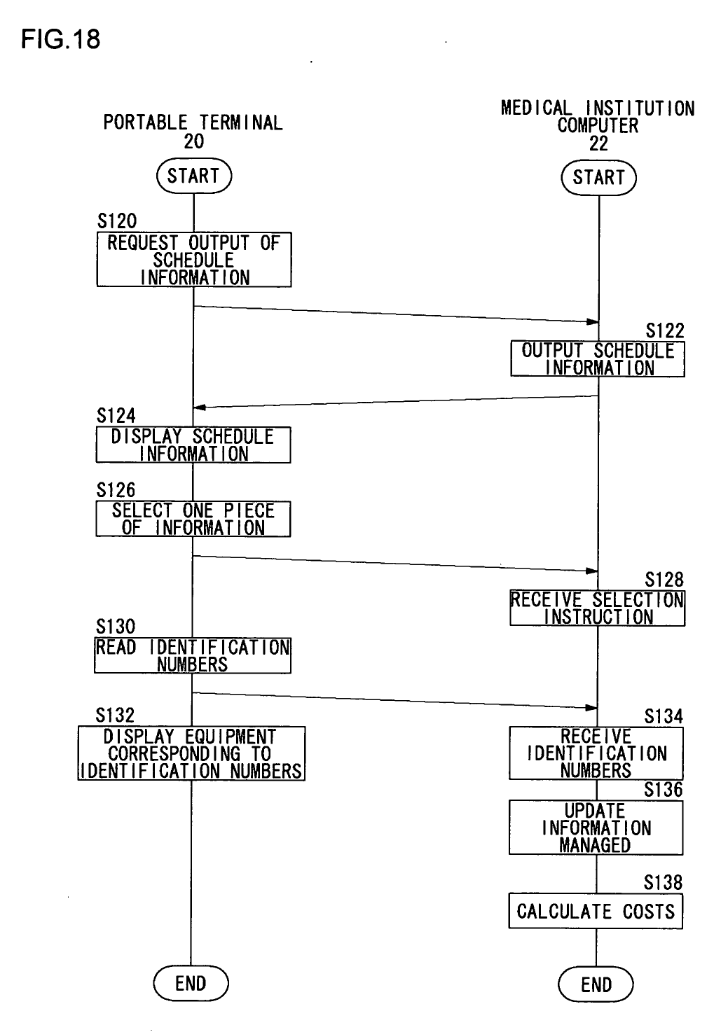

FIG. 18 is a sequence diagram showing the procedure by which the medical practice management system 18 registers administrative details. According to an instruction from the medical practitioner, the portable terminal 20 requests output of a list of schedule information (S120). In response to the request, the medical institution computer 22 outputs the list of schedule information managed (S122). The portable terminal 20 displays the list of schedule information received (S124). Then, according to an instruction from the medical practitioner, the portable terminal 20 selects one piece of schedule information from the list of schedule information displayed (S126), and transmits it to the medical institution computer 22.

The medical institution computer 22 receives the selection instruction from the portable terminal 20 (S128). By using the portable terminal 20, the medical practitioner reads the identification numbers given to medical equipment to be used actually (S130), and transmits them to the medical institution computer 22. The medical institution computer 22 receives the identification numbers from the portable terminal 20 (S134). The medical institution computer 22 transmits the names of the medical equipment corresponding to the identification numbers to the portable terminal 20. Based on the selected schedule information and the read identification numbers, the medical institution computer 22 updates the schedule information managed (S136). The medical institution computer 22 also calculates the costs of the medical practice (S138). In the meantime, the portable terminal 20 displays the names of the medical equipment corresponding to the identification numbers, transmitted from the medical institution computer 22 (S132).

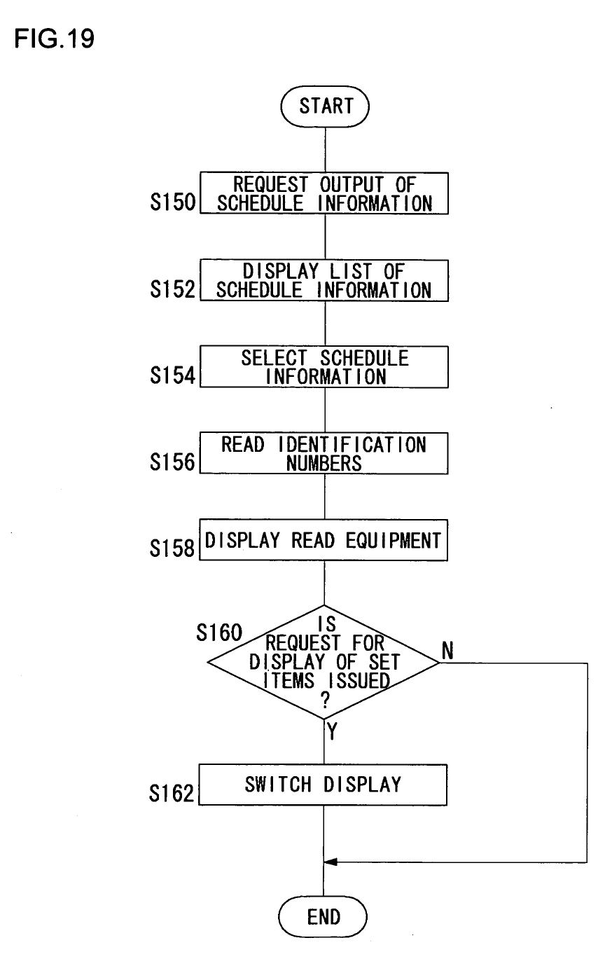

FIG. 19 is a flowchart showing the procedure by which the portable terminal 20 registers administrative contents. The medical practitioner requests the medical institution computer 22 to output a list of schedule information, via the instruction unit 50 (S150). The selection unit 56 displays the list of schedule information received from the medical institution computer 22 (S152). This display corresponds to FIG. 11. According to an instruction from the medical practitioner, the display unit 54 select one piece of schedule information from the list of schedule information (S154). The selected information is transmitted to the medical institution computer 22. By using the reading unit 58, the medical practitioner reads the identification numbers given to medical equipment (S156). The read identification numbers are transmitted to the medical institution computer 22. The display unit 54 displays the names of the medical equipment corresponding to the read identification numbers, transmitted from the medical institution computer 22 (S158). This display corresponds to FIG. 12. Moreover, if a request for display of set items is issued (Y at S160), the display unit 54 switches the display (S162). This display corresponds to FIG. 13. If the display of the set items is not requested (N at S160), the processing is ended.

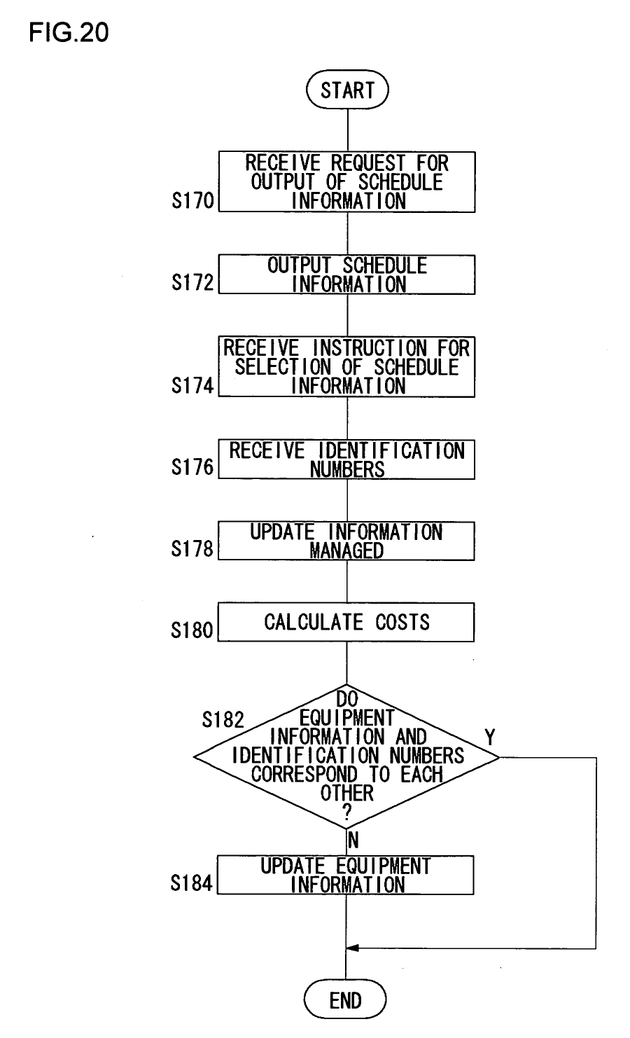

FIG. 20 is a flowchart showing the procedure by which the medical institution computer 22 registers administrative contents. The management unit 74 receives, from the portable terminal 20, an instruction to output the list of schedule information (S170). According to the instruction from the portable terminal 20, the management unit 74 outputs the list of schedule information to the portable terminal 20 (S172). The updating unit 76 receives the instruction for selection of schedule information from the portable terminal 20 (S174). The updating unit 76 receives identification numbers from the portable terminal 20 (S176). Based on the instruction for selection of schedule information and the identification numbers, the updating unit 76 updates the schedule information and the information on medical equipment managed in the management unit 74 (S178).

The calculation unit 82 calculates the costs of the medical practice based on the schedule information and the information on medical equipment managed in the management unit 74, and the cost information stored in the database 70 (S180). Moreover, if the information on medical equipment stored in the database 70 and the identification numbers do not correspond to each other (N at S182), the updating unit 76 updates the information on medical equipment stored in the database 70 (S184). On the other hand, if the information on medical equipment stored in the database 70 and the identification numbers correspond to each other (Y at S182), the updating unit 76 ends the processing.

(Modification 1)

Description will now be given of a modification of the embodiment. As in the foregoing description, the scheduling phase will be described first. In the embodiment, the database 70 establishes association between schedule information and medical equipment. In this modification, the schedule information is defined in more detail. The reason is that surgical operations require much labor and time of nurses in preparing appropriate surgical tools and medicines out of large stocks according to the scheduled techniques. Besides, equipment is often prepared for individual doctors, depending on the preferences of the doctors who are in charge of the respective operations. This makes it difficult to make perfect preparation before operation.

In the modification, the schedule information acquired by the acquisition unit 78 includes at least the name of a doctor to conduct a medical practice and the type of the medical practice. Here, the name of a doctor to conduct a medical practice refers to, for example, the name of the doctor who is in charge of the operation. The type of the medical practice refers to the type of the operation, i.e., the scheduled technique, for example. The scheduled technique corresponds to one of those described in the technique field 200 of FIG. 9A.

The plurality of pieces of information on medical equipment stored in the database 70 are in association with the names of doctors to conduct medical practices and the scheduled techniques. FIG. 9A shows the association between the techniques and the medical equipment. In the modification, the names of doctors are also added into the association. In other words, the medical equipment, the name of a doctor, and the scheduled technique, three are stored in the database 70 in association with one another. The selection unit 72 selects the name of the doctor to conduct the medical practice, acquired by the acquisition unit 78, and the information on medical equipment corresponding to the scheduled technique from the database 70. The management unit 74 manages the name of the doctor to conduct the medical practice, the technique, and the information on medical equipment selected by the selection unit 72 in association with one another. As a result, the names of the doctors are added to FIG. 10. In the foregoing configuration, a primary doctor and a technique are determined once the scheduled practice is fixed. These pieces of information can thus be combined to make optimum preparations.

(Modification 2)

Modification 2 also relates to the scheduling phase. Medical equipment has been heretofore selected so as to correspond to a single technique. A single surgical operation, however, may sometimes include a plurality of techniques. In such cases, managing the medical equipment for a plurality of techniques collectively can make the management of the medical equipment easier than to managing the medical equipment in association with each individual technique. The schedule information acquired by the acquisition unit 78 includes a plurality of types of medical practices, i.e., a plurality of scheduled techniques. The scheduled techniques are the same as described previously. The selection unit 72 selects the information on medical equipment corresponding to each of the plurality of scheduled techniques acquired by the acquisition unit 78 from the database 70. The management unit 74 manages the information on medical equipment selected by the selection unit 72 collectively, regardless of the plurality of scheduled techniques acquired by the acquisition unit 78. Here, “managing collectively” refers to summing up the numbers of respective units of medical equipment before management.

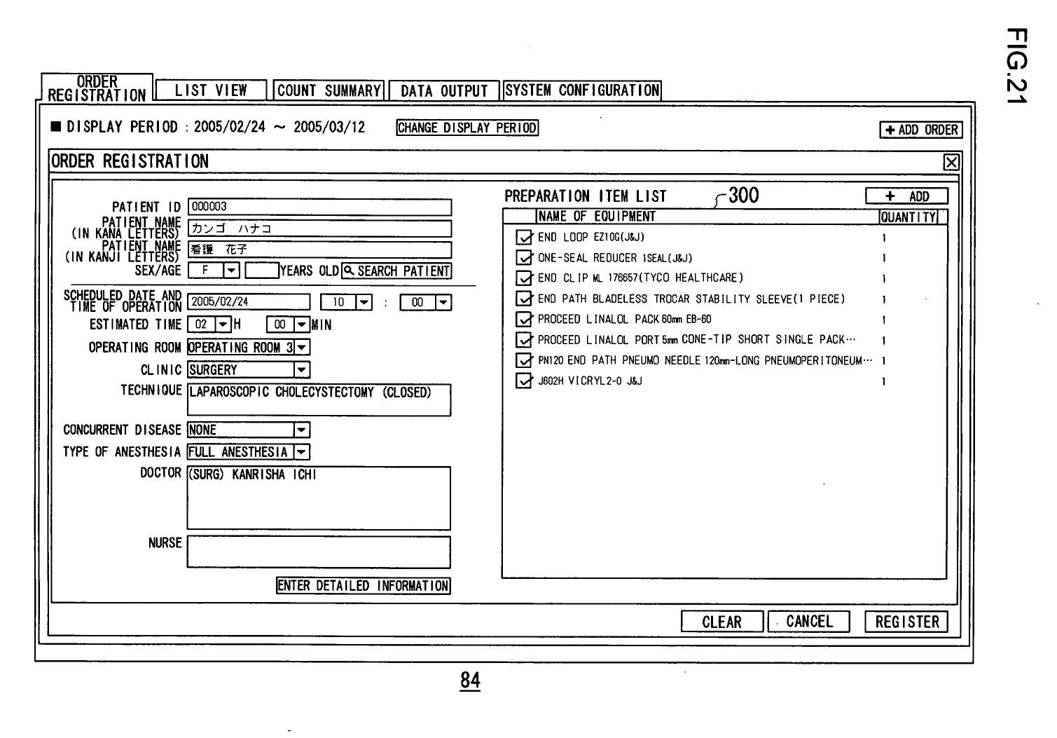

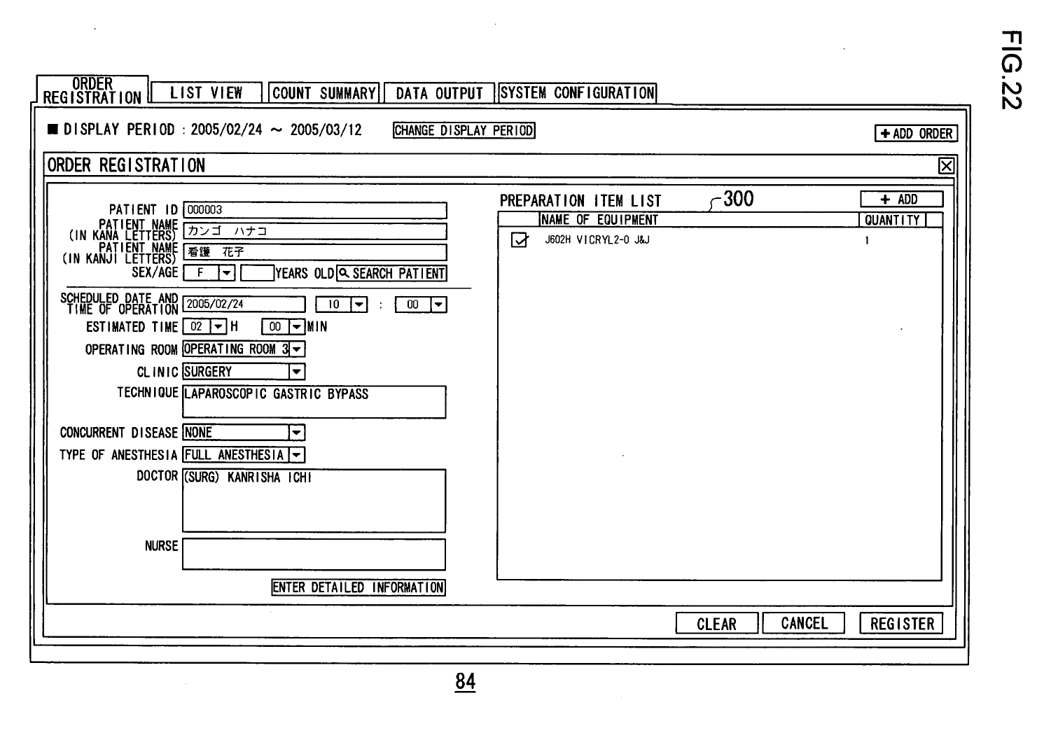

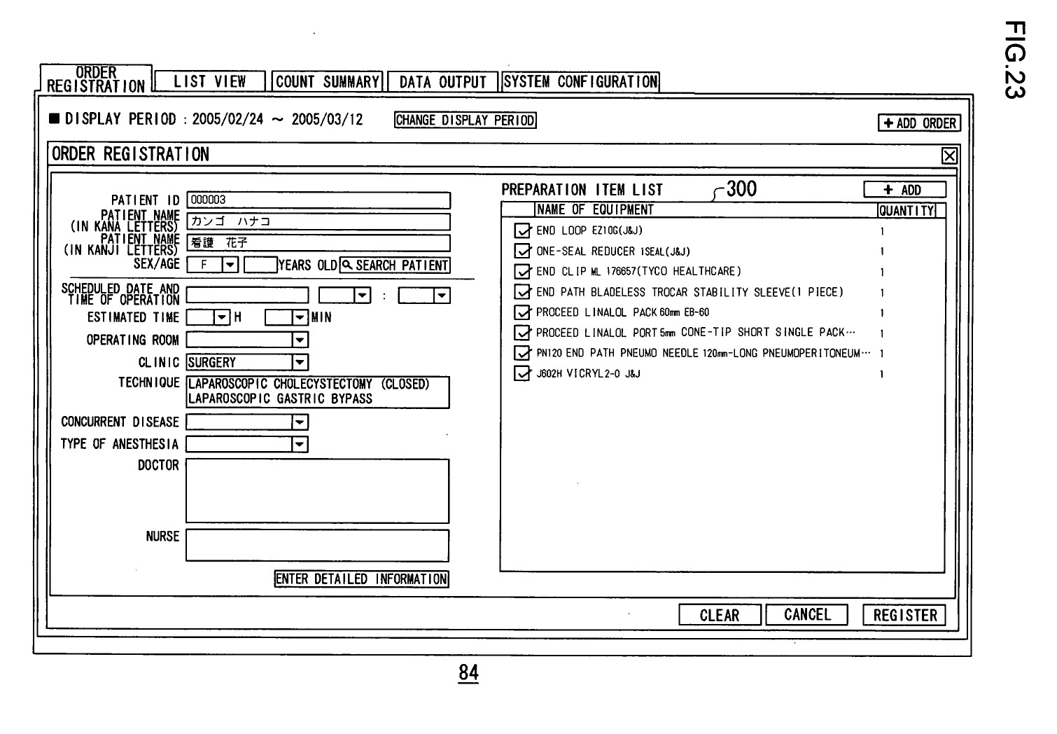

FIG. 21 shows a screen for a preparation item list, which appears on the display unit 84 according to the modification of the present invention. The acquisition unit 78 acquires “laparoscopic cholecystectomy (closed)” as the scheduled technique. The selection unit 72 selects medical equipment corresponding to “laparoscopic cholecystectomy (closed)” from the database 70. The display unit 84 displays the selected medical equipment in the preparation item list 300. FIG. 22 shows another screen for a preparation item list, which appears on the display unit 84 according to the modification of the present invention. This screen shows a preparation item list corresponding to a scheduled technique to be conducted in the same surgical operation as the scheduled technique displayed in FIG. 21 is. The acquisition unit 78 acquires “laparoscopic gastric bypass” as the scheduled technique. The selection unit 72 selects medical equipment corresponding to “laparoscopic gastric bypass” from the database 70. The display unit 84 displays the selected medical equipment in the preparation item list 300. FIG. 23 shows still another screen for a preparation item list, which appears on the display unit 84 according to the modification of the present invention. This screen corresponds to a collective list of preparation items for the scheduled technique displayed in FIG. 21 and the scheduled technique displayed in FIG. 22. The acquisition unit 78 acquires “laparoscopic cholecystectomy (closed)” and “laparoscopic gastric bypass” as the scheduled techniques. The management unit 74 sums up the information on medical equipment corresponding to both the techniques. That is, the management unit 74 counts up the quantities of the same units of medical equipment. The display unit 84 displays the summation of the medical equipment on the preparation item list 300.

(Modification 3)

Modification 3 relates to the administrative phase. The reading unit 58 of the embodiment reads, from exterior, the identification numbers assigned to the medical equipment to be used actually in the medical practice going to be administered. Here, the portable terminal 20 reads identification numbers each including commodity code, quantity, expiration date, and lot number (such as ones compliant with EAN-128). When the identification number of an identical commodity is read more than once, however, the quantity of the identical commodities will not be counted up automatically due to the single-item counting. It follows that as many commodities as read appear in a list view. Consequently, if the identification numbers of a plurality of commodities are read, it is of poor usability to check on the small screen of the display unit 54. For this reason, this modification includes the following processing.

The identification numbers read by the reading unit 58 include information on quantity and commodity code. The information on quantity refers to the quantities of respective items of medical equipment included in a single kit when a plurality of items of medical equipment are grouped into the single kit. In this case, an identification number is given to the single kit. When the information on quantity and the commodity code are read by the reading unit 58, the updating unit 76 ignores the information on quantity and counts up the number of reads of the commodity code, in units of the commodity code. The display units 54 and 84 display the count result. To be more specific, the updating unit 76 compares the read commodity code and commodity codes that are read previously. If the commodity codes match, the updating unit 76 counts up the quantity.

Moreover, when the commodity codes of identical items of medical equipment are read and the updating unit 76 counts up the quantity, the updating unit 76 may discard the expiration date and the lot number. To be more specific, the updating unit 76 compares the read commodity code and commodity codes that are read previously. If the commodity codes match, the updating unit 76 counts up the quantity. In counting up the quantity, the updating unit 76 discards the expiration date and the lot number.

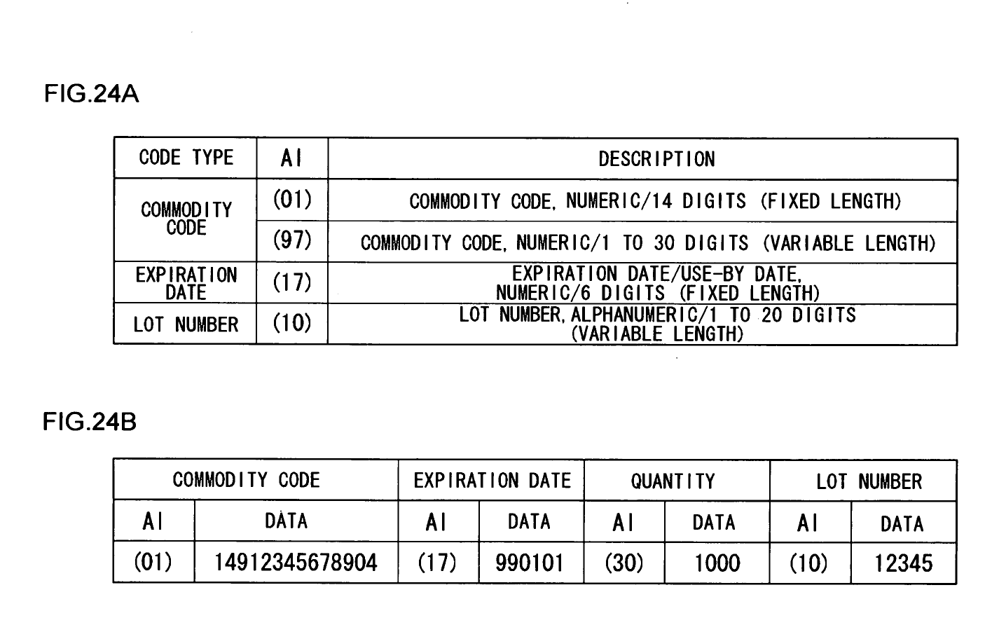

FIGS. 24A and 24B show the configuration of the identification number according to the modification of the present invention. Incidentally, the identification number is compliant with EAN-128. FIG. 24A shows “code types” included in the identification number. The “code types” include “commodity code,” “expiration date,” and “lot number.” The chart also shows “AI” and “Description” for each “code type.” FIG. 24B shows concrete examples of the identification number. In the chart, the concrete examples shown in the bottom row correspond to “commodity code,” “expiration date,” “quantity,” and “lot number” shown in the top row.

(Modification 4)

Modification 4 also relates to the administrative phase. For administration entry, the medical practitioner heretofore has had to enter which pieces of medical equipment are used one by one. This has required much labor. As described so far, the selection unit 72 has selected medical equipment or preparation items in the scheduling phase. In this modification, the pieces of medical equipment used in a surgical operation are also displayed in a preparation item list. When the updating unit 76 receives instructions from the medical practitioner via the editing unit 80, it makes changes to the information on medical equipment corresponding to the schedule information selected in the database 70. The display unit 84 displays the information on medical equipment upon which the changes are reflected. Incidentally, the updating unit 76 may update the combinations stored in the database 70 so that the changes are reflected thereon.

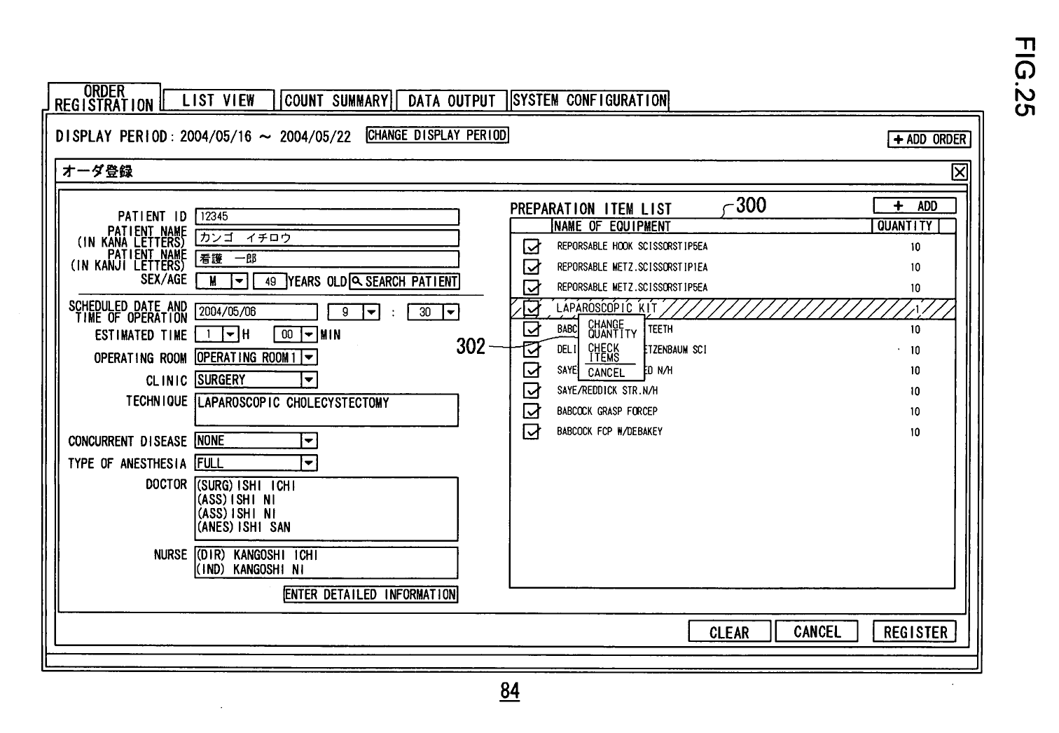

FIG. 25 shows a screen for a preparation item list, which appears on the display unit 84 according to the modification of the present invention when clicked. A preparation item list click menu 302 is intended to make changes to the quantities of the equipment displayed on the preparation item list 300, check the items of a kit, or cancel the click menu itself. When “Change Quantity” is selected, a quantity screen appears to enable a quantity change from the editing unit 80. When the piece of equipment concerned is a kit and “Check Items” is selected, the display unit 84 shows a screen for displaying the items of the kit.

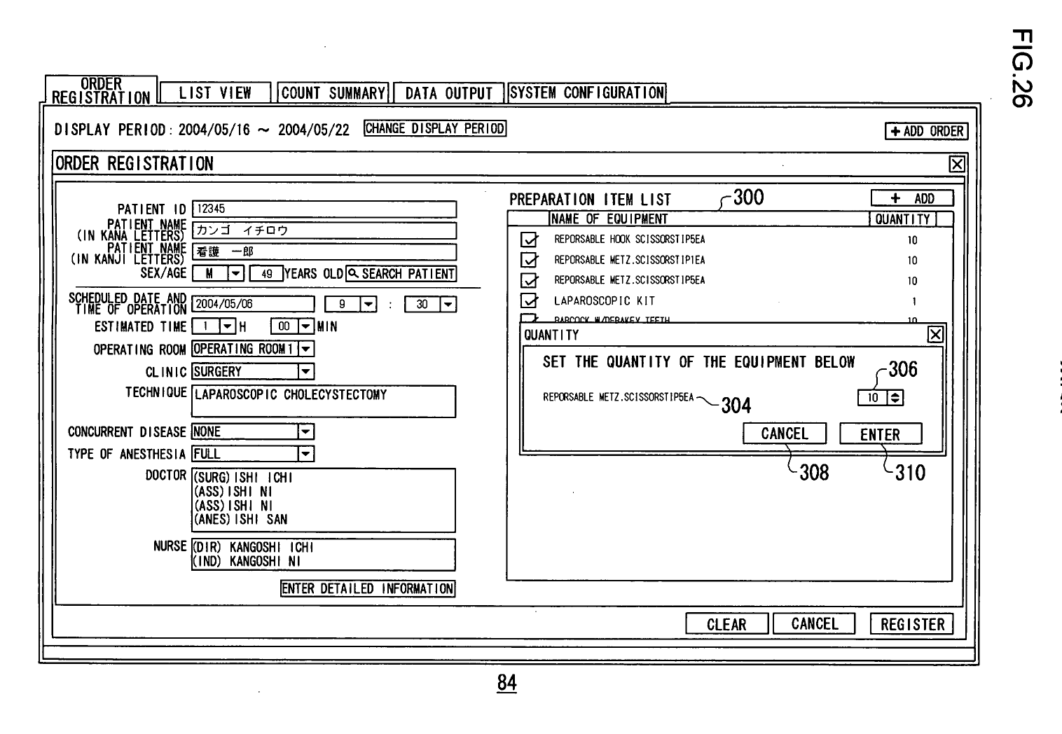

FIG. 26 shows a screen for changing the quantity of a preparation item, which appears on the display unit 84 according to the modification of the present invention. A quantity change equipment name field 304 displays the name of the equipment selected. The editing unit 80 edits the quantity by editing a quantity field 306 directly or via the up/down buttons. A “Cancel” button 308 is pressed to cancel the change to the quantity of the equipment concerned. An “Enter” button 310 is pressed to fix the change to the quantity of the equipment concerned.

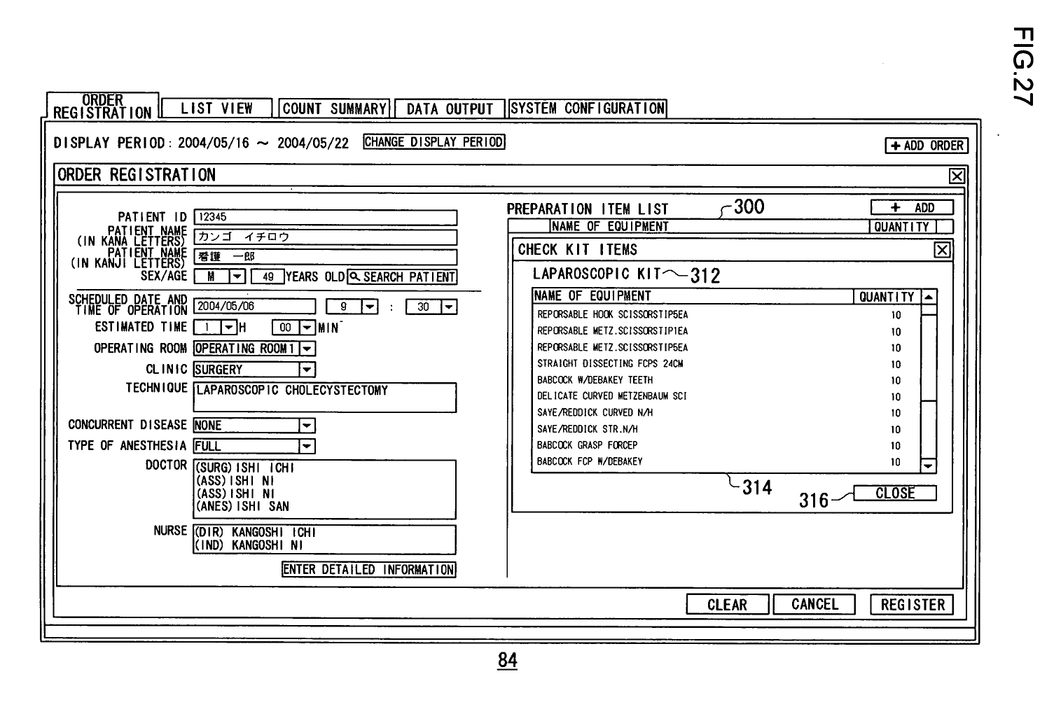

FIG. 27 shows a screen for checking the details of a preparation item kit, which appears on the display unit 84 according to the modification of the present invention. A kit name field 312 displays the name of the kit concerned. A kit item list 314 displays a list of component items of this kit in the database 70. This list is shown by default in the order of display of equipment masters. A “Close” button 316 closes this screen.

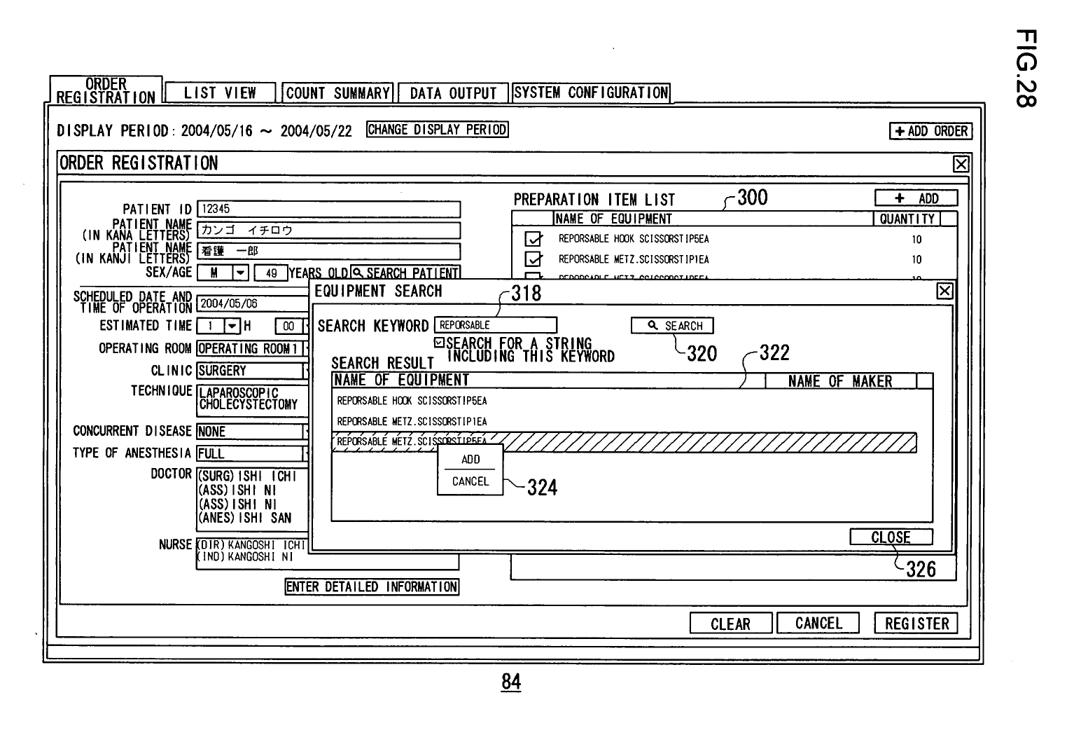

FIG. 28 shows a screen for adding preparation items, which appears on the display unit 84 according to the modification of the present invention. A search keyword entry area 318 accepts a keyword for equipment search. The check box below the search keyword entry area 318 can be checked to search including the entered keyword. When a “Search” button 320 is clicked, the selection unit 72 performs a search for the keyword that is entered in the search keyword entry area 318. If any hit, the search result is displayed in a search result display area 322. If no hit, a message dialog for notifying of no hit is displayed. When no specification word is entered into the search keyword entry area 318, a confirmation dialog as to whether or not to perform a full search appears, and the selection unit 72 performs a full search. The search result is displayed in the search result display area 322.

The search result display area 322 shows the search result in a list view. When an equipment item in question is clicked on the search result, a search result click menu 324 is opened. The search result click menu 324 appears when the equipment item in question is clicked on the search result. If “Add” is selected, a quantity screen is opened. The quantity screen shall display a default quantity in advance. When an “OK” button on the quantity screen is pressed, the message that the equipment is added to the preparation item list 300 appears, and this item of equipment is added to the preparation item list 300. A “Close” button 326 closes this screen.

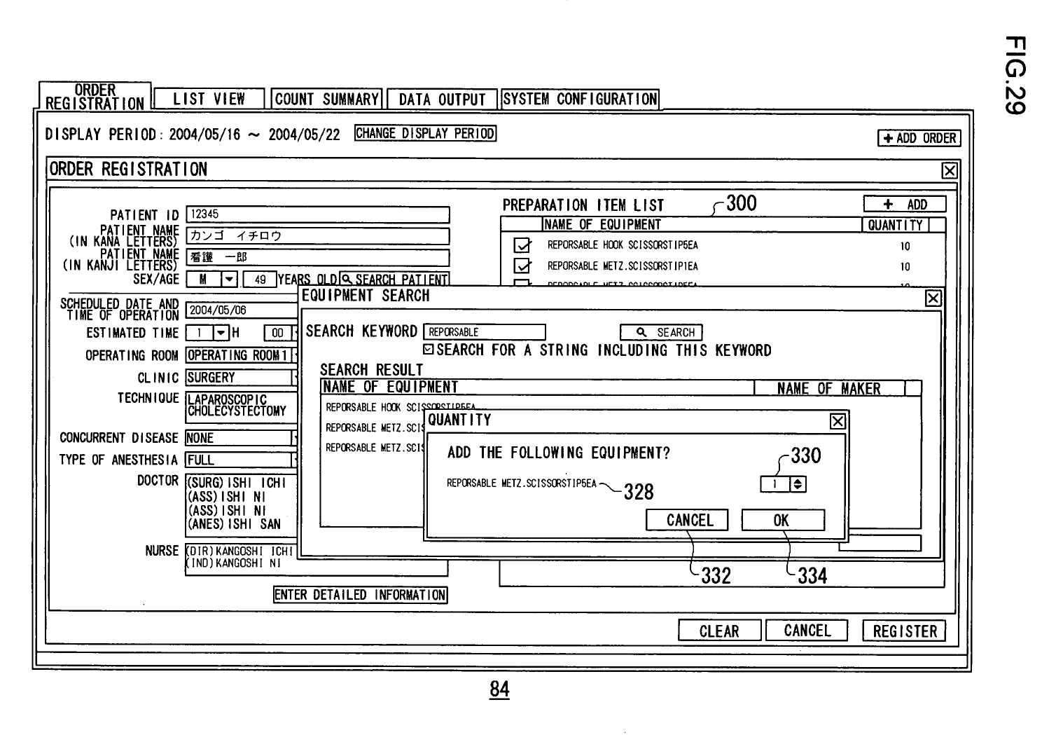

FIG. 29 shows another screen for adding preparation items, which appears on the display unit 84 according to the modification of the present invention. An additional equipment name field 328 shows the name of the additional item of equipment selected from the search result. A quantity field 330 shows a default quantity of the additional item in a predetermined unit. The editing unit 80 edits the quantity by direct editing or via the up/down buttons. A “Cancel” button 332 cancels the addition to the quantity field 330 of this item. After cancelled, the screen returns to the previous state where the search result is displayed. An “OK” button 334 fixes the addition of this item to the preparation item list 300. After the addition, an addition completion message dialog is displayed to return to the previous screen where the search result is displayed.

According to embodiment 1 of the present invention, a plurality of combinations of schedule information and information on medical equipment are stored in advance. According to acquired schedule information, information on medical equipment is acquired from among the stored combinations. The acquired information on medical equipment and the acquired schedule information are associated with each other before management of this schedule information. It is therefore possible to acquire predetermined pieces of information on medical equipment. Moreover, since the information on medical equipment can be automatically acquired according to the schedule information without any input of the information on medical equipment, it is possible to reduce the burden on the medical practitioner. Since predetermined pieces of information on medical equipment are acquired, it is also possible to reduce errors in generating the information on medical equipment.

The schedule information is input through the simple process of selecting one from among a plurality of alternatives. This can reduce the burden of the schedule information input processing on the medical practitioner. Information revisions are also possible. In addition, the schedule information on medical practices and the administrative contents of the actual medical practices can be managed in association with each other. Besides, managing the schedule information and the administrative contents in association with each other allows centralized management of the plurality of types of information. The information under the centralized management can also be subjected to predetermined processing for the sake of secondary uses of information. The schedule information and the administrative contents can be compared to generate schedule information that is closer to the administrative contents. It is also possible to reduce unnecessary stocks. Since the medical practitioner who prepares medical equipment can check which pieces of medical equipment to prepare, it is possible to prepare medical equipment that is necessary for the medical practice.

The use of the portable terminal eliminates the need for printouts, thereby allowing a reduction in paper consumption. It is also possible to clarify the costs of medical practices. Revenue and expenditure calculations are also facilitated. Since the combinations of the schedule information and the information on medical equipment stored in advance are updated according to which pieces of medical equipment are used in actual medical practices, it is possible to improve the reliability of the combinations. The server-and-portable-terminal configuration allows the medical practitioner to access the information inside the server even at locations remote from the server.

The information on medical equipment is stored in association with the names of doctors and scheduled techniques. It is therefore possible to improve the precision of selection of the information on medical equipment. Since the pieces of information on medical equipment corresponding to a single piece of schedule information are collected together, the information on medical equipment for the single piece of schedule information can be grasped easily. In addition, commodity codes are automatically counted up when read. This can facilitate the processing of the medical practitioner. Since the information on medical equipment is modified before display, it is possible to show the information on medical equipment conforming to the current state. Since the combinations are also updated to reflect changes, it is possible to store combinations that are closer to the current state.

The invention described in embodiment 1 may be defined as follows:

A medical practice management system according to one of the aspects of the present embodiment comprises: an acquisition unit which acquires schedule information on a medical practice to be administered to a patient; a storing unit which stores a plurality of pieces of information on medical equipment to be used in medical practices in association with a plurality of pieces of schedule information, respectively; a selection unit which selects information on medical equipment corresponding to the schedule information acquired by the acquisition unit, from among the plurality of pieces of information on medical equipment stored in the storing unit; and a management unit which manages the acquired schedule information and the information on medical equipment selected by the selection unit in association with each other.

The “medical equipment” refers to matters for use in medical practices. The “medical equipment” shall also include, but not be limited to, medicines. Even gases are also included. Any matters are applicable as long as they are used in medical practices. The “schedule information” refers to information for specifying a medical practice to be administered in the future. The schedule information may include a plurality of items, and one of the plurality of items may be referred to as “schedule information.”

According to this aspect, a plurality of combinations of the information on medical equipment and the schedule information, such as the names of interventions, are stored in advance. When schedule information is acquired, information on medical equipment is acquired from among the combinations stored. Then, the acquired information on medical equipment and the acquired schedule information are associated with each other before management of this schedule information. It is therefore possible to acquire predetermined pieces of information on medical equipment.

The medical practice management system may further comprise a display unit for displaying a plurality of pieces of schedule information when the acquisition unit acquires schedule information. The acquisition unit may acquire the schedule information by having a medical practitioner select any one of the plurality of pieces of schedule information displayed on the display unit.

The “medical practitioner” typically means one who administers medical practices, such as a doctor and a nurse. Nevertheless, the “medical practitioner” here shall not only refer to one who administers medical practices directly, but also one who operates under the instructions of a doctor, a nurse, or the like. In this case, since the medical practitioner has only to select one from among the plurality of alternatives, the burden on the medical practitioner can be reduced.

The medical practice management system may further comprise an editing unit from which the medical practitioner edits at least either the schedule information or the information on medical equipment to be managed by the management unit. This allows information revisions.

The schedule information acquired by the acquisition unit may include at least the name of a doctor to conduct the medical practice and the type of the medical practice. Here, the plurality of pieces of information on medical equipment stored in the storing unit may be associated with the names of doctors to conduct medical practices and the types of the medical practices. The selection unit may select the information on medical equipment corresponding to the name of the doctor to conduct the medical practice and the type of the medical practices, acquired by the acquisition unit. The management unit may manage the acquired name of the doctor to conduct the medical practice, the type of the medical practice, and the information on medical equipment selected by the selection unit in association with one another. For example, the “type of a medical practice” corresponds to the type of the technique, whereas other medical practices may be included. In this case, the information on medical equipment is stored in association with the names of doctors and the types of medical practices. It is therefore possible to improve the precision of selection of the information on medical equipment.

The schedule information acquired by the acquisition unit may include the types of a plurality of medical practices. Here, the selection unit may select pieces of information on medical equipment corresponding to the respective types of the plurality of medical practices acquired by the acquisition unit. The management unit may manage the pieces of information on medical equipment selected by the selection unit collectively, regardless of the types of the plurality of medical practices acquired by the acquisition unit. In this case, the pieces of information on medical equipment corresponding to a single piece of schedule information are collected together. The information on medical equipment for the single piece of schedule information can thus be grasped easily.

Another aspect of the present embodiment is also a medical practice management system. This medical practice management system comprises: a storing unit which stores a plurality of combinations of schedule information on medical practices to be administered to patients and information on medical equipment to be used in the medical practices in association with each other; a selection unit which selects schedule information corresponding to a medical practice going to be administered, from among the plurality of combinations stored in the storing unit, under an instruction from a medical practitioner; a reading unit which reads, from exterior, an identification code assigned to medical equipment to be used actually in the medical practice going to be administered; and an updating unit which associates the information on medical equipment corresponding to the schedule information selected by the selection unit, out of the plurality of combinations stored in the storing unit, with the identification code read by the reading unit, and updates the combinations stored in the storing unit.

According to this aspect, the schedule information on medical practices and the administrative contents of actual medical practices can be managed in association with each other.

The medical practice management system may further comprise a display unit for displaying a plurality of pieces of schedule information stored in the storing unit when the selection unit selects schedule information. The selection unit may make the medical practitioner select any one of the plurality of pieces of schedule information displayed on the display unit, thereby selecting the schedule information corresponding to the medical practice going to be administered. In this case, since the medical practitioner has only to select one from among the plurality of alternatives, it is possible to facilitate the processing of the medical practitioner.

The display unit may display the information on medical equipment corresponding to the schedule information selected by the selection unit. Since the medical practitioner who prepares medical equipment can check which pieces of medical equipment to prepare, the medical equipment is prepared more accurately than in an empirical fashion.

The identification code read by the reading unit may include information on quantity and an identification number. Here, when the identification code is read by the reading unit, the updating unit may ignore the information on quantity and count up the number of reads of the identification number, in units of the identification number. In this case, identification numbers are automatically counted up when each is read. This can facilitate the processing of the medical practitioner.

The medical practice management system may further comprise: a modification unit which modifies the information on medical equipment corresponding to the schedule information selected by the selection unit; and a display unit which displays the information on medical equipment upon which the modification made by the modification unit is reflected. In this case, the information on medical equipment is modified before display. This makes it possible to display the information on medical equipment conforming to the current state.

The updating unit may update the combinations stored in the storing unit so that the modification made by the modification unit is reflected thereon. Since the combinations are updated to reflect the modification, it is possible to store combinations that are closer to the current state.

The storing unit may store costs of the medical equipment. The medical practice management system may further comprise a calculation unit which identifies medical equipment based on the identification number read by the reading unit and adds up the costs of the medical equipment based on the identified medical equipment, with reference to the storing unit. In this case, it is possible to clarify the costs of medical practices, or the costs for each single intervention in particular.

The storing unit may also store labor costs for medical practitioners. Here, the selection unit also selects a medical practitioner to administer a medical practice under an instruction from a medical practitioner. With reference to the storing unit, the calculation unit identifies labor costs for the medical practitioner selected by the selection unit, and includes the identified labor costs into the costs of the medical practice going to be administered. In this case, it becomes possible to clarify the costs including the labor costs.

Still another aspect of the present embodiment is also a medical practice management system. This medical practice management system comprises: an acquisition unit which acquires schedule information on a medical practice to be administered to a patient; a storing unit which stores a plurality of pieces of information on medical equipment to be used in medical practices in association with a plurality of pieces of schedule information, respectively; a selection unit which selects information on medical equipment corresponding to the schedule information acquired by the acquisition unit, from among the plurality of pieces of information on medical equipment stored in the storing unit; a reading unit which reads, from exterior, an identification number assigned to medical equipment to be used actually in a medical practice corresponding to the information on medical equipment selected by the selection unit, the medical practice being going to be administered by a medical practitioner; and an updating unit which updates the plurality of pieces of information on medical equipment stored in the storing unit based on a difference between the information on medical equipment selected by the selection unit and the identification number read by the reading unit.

According to this aspect, the combinations of the schedule information and the information on medical equipment stored in advance are updated according to which pieces of medical equipment are used in actual medical practices. It is therefore possible to improve the reliability of the combinations.

Still another aspect of the present embodiment is a portable terminal. This terminal comprises: a receiving unit which receives a plurality of combinations of schedule information on medical practices to be administered to patients and information on medical equipment to be used in the medical practices in association with each other, from a server containing the plurality of combinations; a display unit which displays a plurality of pieces of schedule information out of the plurality of combinations received by the receiving unit; a selection unit which selects schedule information corresponding to a medical practice going to be administered, from among the plurality of pieces of schedule information displayed on the display unit, under an instruction from a medical practitioner; a reading unit which reads, from exterior, an identification number assigned to medical equipment to be used actually in the medical practice going to be administered; and a transmission unit which transmits, to the server, the information on medical equipment corresponding to the schedule information selected by the selection unit, out of the plurality of combinations received by the receiving unit, in association with the identification number read by the reading unit.

According to this aspect, it is possible to manage the schedule information on medical practices and the administrative contents of the actual medical practices in association with each other, even at locations remote from the server.

Still another aspect of the present embodiment is a management server. This management server comprises: an acquisition unit which acquires schedule information on a medical practice to be administered to a patient; a storing unit which stores a plurality of pieces of information on medical equipment to be used in medical practices in association with a plurality of pieces of schedule information, respectively; a selection unit which selects information on medical equipment corresponding to the schedule information acquired by the acquisition unit, from among the plurality of pieces of information on medical equipment stored in the storing unit; and a management unit which manages the acquired schedule information and the information on medical equipment selected by the selection unit in association with each other.

According to this aspect, a plurality of combinations of the schedule information and the information on medical equipment are stored in advance. When schedule information is acquired, information on medical equipment is acquired from among the combinations stored. Then, the acquired information on medical equipment and the acquired schedule information are associated with each other before management of this schedule information. It is therefore possible to acquire predetermined pieces of information on medical equipment.

Still another aspect of the present embodiment is also a management server. This management server comprises: a storing unit which stores a plurality of combinations of schedule information on medical practices to be administered to patients and information on medical equipment to be used in the medical practices in association with each other; a selection unit which selects schedule information corresponding to a medical practice going to be administered, from among the plurality of combinations stored in the storing unit, under an instruction from a medical practitioner; a receiving unit which receives an identification number assigned to medical equipment to be used actually in the medical practice going to be administered; and an updating unit which associates the information on medical equipment corresponding to the schedule information selected by the selection unit, out of the plurality of combinations stored in the storing unit, with the identification number received by the receiving unit, and updates the combinations stored in the storing unit.

According to this aspect, the schedule information on medical practices and the administrative contents of the actual medical practices can be managed in association with each other.

Still another aspect of the present embodiment is also a management server. This management server comprises: an acquisition unit which acquires schedule information on a medical practice to be administered to a patient; a storing unit which stores a plurality of pieces of information on medical equipment to be used in medical practices in association with a plurality of pieces of schedule information, respectively; a selection unit which selects information on medical equipment corresponding to the schedule information acquired by the acquisition unit, from among the plurality of pieces of information on medical equipment stored in the storing unit; a reading unit which reads, from exterior, an identification number assigned to medical equipment to be used actually in a medical practice corresponding to the information on medical equipment selected by the selection unit, the medical practice being going to be administered by a medical practitioner; and an updating unit which updates the plurality of pieces of information on medical equipment stored in the storing unit based on a difference between the information on medical equipment selected by the selection unit and the identification number read by the reading unit.

According to this aspect, the combinations of the schedule information and the information on medical equipment stored in advance are updated according to which pieces of medical equipment are used in actual medical practices. It is therefore possible to improve the reliability of the combinations.

Still another aspect of the present embodiment is a medical practice management method. This method comprises: acquiring schedule information on a medical practice to be administered to a patient; selecting information on medical equipment corresponding to the acquired schedule information, from among a plurality of pieces of information on medical equipment to be used in medical practices, the plurality of pieces of information on medical equipment being stored in a memory in association with a plurality of pieces of schedule information, respectively; and managing the acquired schedule information and the selected information on medical equipment in association with each other.

Still another aspect of the present embodiment is also a medical practice management method. This method comprises: selecting schedule information corresponding to a medical practice going to be administered, under an instruction from a medical practitioner, from among a plurality of combinations of schedule information on medical practices to be administered to patients and associated information on medical equipment to be used in the medical practices, the plurality of combinations being stored in a memory; reading, from exterior, an identification number assigned to medical equipment to be used actually in the medical practice going to be administered; and associating the information on medical equipment corresponding to the selected schedule information, out of the plurality of combinations stored in the memory, with the read identification number, and updating the combinations stored in the memory.

Still another aspect of the present embodiment is also a medical practice management method. This method comprises: acquiring schedule information on a medical practice to be administered to a patient; selecting information on medical equipment corresponding to the acquired schedule information, from among a plurality of pieces of information on medical equipment to be used in medical practices, the plurality of pieces of information on medical equipment being stored in a memory in association with a plurality of pieces of schedule information, respectively; reading, from exterior, an identification number assigned to medical equipment to be used actually in a medical practice corresponding to the selected information on medical equipment, the medical practice being going to be administered by a medical practitioner; and updating the plurality of pieces of information on medical equipment stored in the memory based on a difference between the selected information on medical equipment and the read identification number.

### Embodiment 2

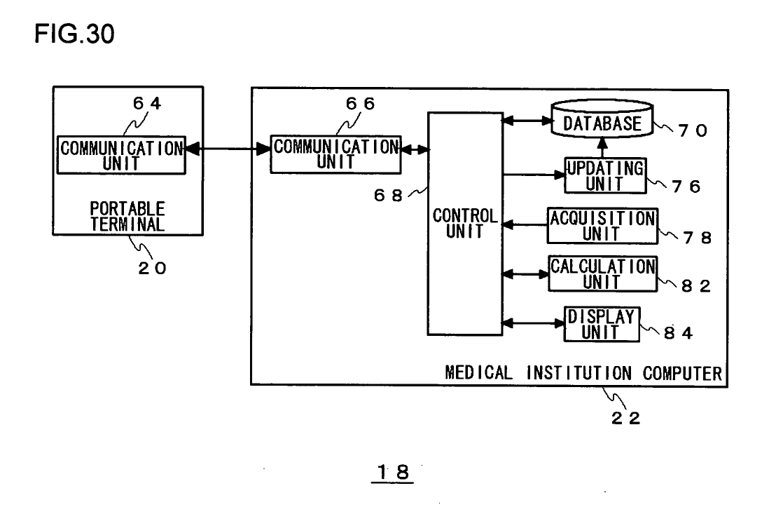

Now, description will be given of embodiment 2 of the present invention. Embodiment 2 provides a medical practice management system 18 which manages costs for each single medical practice accurately. FIG. 30 is a diagram showing a first configuration of the medical practice management system 18 according to embodiment 2 of the present invention. The first configuration of this medical practice management system 18 includes a portable terminal 20 and a medical institution computer 22 as described previously. Since the portable terminal 20 may have the same configuration and operation as in embodiment 1, description thereof will be omitted here. The medical institution computer 22 includes a communication unit 66, a control unit 68, a database 70, an updating unit 76, an acquisition unit 78, a calculation unit 82, and a display unit 84.

The acquisition unit 78 according to embodiment 2 acquires administrative information which concerns medical practices to be administered to patients or medical practices administered to patients. The administrative information includes information necessary to calculate costs for a single medical practice accurately. For example, the information includes the name of a patient, an operating room, the start time of an operation, the operating time, an operator, a technique, used medical equipment, the presence or absence of concurrent diseases, and cases thereof. As for the operator, the acquisition unit 78 acquires information for identifying a doctor, nurse, and others specifically. An example of the information is a staff code. For medical equipment and medical instruments to be used, information for identifying them specifically, such as an identification number, is acquired.

The acquisition unit 78 may acquire the foregoing administrative information by any method. For example, after the administration of medical practices such as a surgical operation and an outpatient care, one or more medical practitioners may simply input the administrative information via the portable terminal 20 or directly into the medical institution computer 22. Otherwise, schedule information may be registered into the medical institution computer 22 in advance as described in embodiment 1. In the administrative phase, the information is then updated as appropriate to generate the final administrative information. For example, in FIG. 7, the updating unit 76 may read identification numbers assigned to medical equipment used actually from the reading unit 58, and update the items of the foregoing schedule information pertaining to the medical equipment. Moreover, medical practitioners may edit the schedule information that has been registered in the scheduling phase, via the editing unit 80 of FIG. 7 before or after the administration of medical practices. The acquisition unit 78 of embodiment 2 shall be a component that comprehensively represents the acquisition of administrative information by various methods like these.

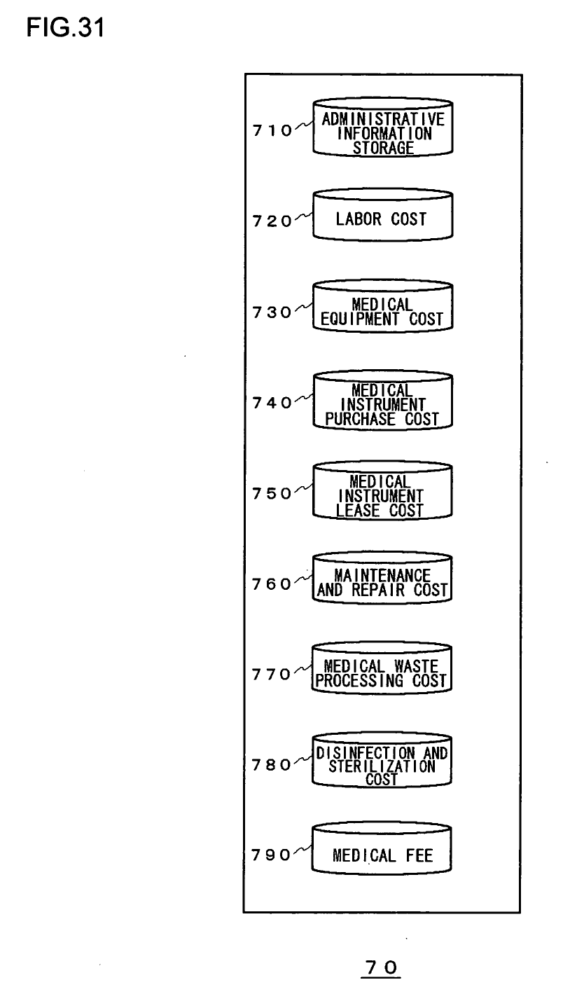

FIG. 31 shows the details of the database 70 according to embodiment 2. The database 70 includes an administrative information storage database 710, a labor cost database 720, a medical equipment cost database 730, a medical instrument purchase cost database 740, a medical instrument lease cost database 750, a maintenance and repair cost database 760, a medical waste processing cost database 770, a disinfection and sterilization cost database 780, and a medical fee database 790.

The administrative information storage database 710 stores the administrative information acquired by the acquisition unit 78. The administrative information to be stored includes such items as shown in FIG. 16 with respect to each medical practice. Other items such as the presence or absence of concurrent diseases may also be included. The labor cost database 720 manages hourly wages, per-operation allowances, and the like for respective medical practitioners including operators, nurses, and technologists. Even with the same type of job, hourly wages and other salaries vary depending on the service years and skill levels. This requires practitioner-by-practitioner management. The labor costs can be calculated, for example, by multiplying the hourly wages registered in the labor cost database 720 by the hours of administration of medical practices included in the administrative information. When a new medical practitioner is registered or the salaries of existing medical practitioners are changed, the updating unit 76 of embodiment 2 updates the contents of the labor cost database 720.

The medical equipment cost database 730 manages the unit prices of the medical equipment piece by piece as shown in FIG. 9B. As employed in this specification document, the term “medical equipment” also covers medicines. The unit prices of medicines are thus also managed by the medical equipment cost database 730. The medical instrument purchase cost database 740 manages the purchase costs of medical instruments purchased previously. The medical instrument lease cost database 750 manages the lease costs for leased medical instruments if any. The maintenance and repair cost database 760 manages the maintenance and repair costs of the medical instruments and other hospital facilities. When the maintenance and repair costs vary depending on the medical instruments, instrument-by-instrument management is exercised. Since it is essential only that the costs pertaining to the medical equipment recorded in the administrative information be managed, the data stored in the medical equipment cost database 730, the medical instrument purchase cost database 740, and the medical instrument lease cost database 750 is utilized according to need.

The medical waste processing cost database 770 manages the costs that are required in processing medical wastes including disposable products such as forceps and operative tools, scalpels, ampoules, absorbent cotton, bandages, and waste blood. The medical waste processing cost database 770 manages unit prices by class or by the amount of discharge of the medical wastes. The disinfection and sterilization cost database 780 manages the costs for cleaning, disinfecting, and sterilizing medical equipment used in the medical institution, such as endoscopes, operative tools, scalpels, forceps, and syringes. If the disinfection and sterilization are committed to outside agents, the unit prices for the respective pieces of medical equipment and fiber products are set in accordance with the fee structures of the agents. The disinfection and sterilization cost database 780 manages those unit prices.

When some changes are made to the unit prices and other items in the medical equipment cost database 730, the medical instrument purchase cost database 740, the medical instrument lease cost database 750, the maintenance and repair cost database 760, the medical waste processing cost database 770, and the disinfection and sterilization database 780, the updating unit 76 of embodiment 2 also updates the contents of these databases as is the case with the labor cost database 720.

The medical fee database 790 manages official prices for service fees which the medical institution charges for individual healthcare interventions, such as medications, inspections, and surgical operations. Since the medical equipment including medicines is also charged for as medical fees, their official prices are also managed.

Returning to FIG. 30, the calculation unit 82 consults the database 70 to calculate costs for each single medical practice. Here, a single medical practice shall conceptually include a single intervention, or a single unit of surgical operation, and a single inspection. The costs for a single medical practice are given by the following equation 1:
Costs for a single medical practice=medical equipment costs+labor costs+medical instrument purchase costs+medical instrument lease costs+maintenance and repair costs+medical waste processing costs+disinfection and sterilization costs (Eq. 1)

In order to calculate the medical equipment costs and the like in the foregoing equation 1, the calculation unit 82 initially consults the administrative information storage database 710 to identify the types and quantities of medical equipment used in the medical practice concerned, the medical practitioners, the amounts of medical wastes, etc. Subsequently, the calculation unit 82 identifies the unit prices corresponding to the identified types and quantities from the labor cost database 720 and the like. Then, the calculation unit 82 can multiply the corresponding items by each other to work out the individual cost items. Incidentally, if no medical instrument is purchased, that cost item will not be summed up.

The calculation unit 82 also consults the administrative information storage database 710 to identify the medical practice administered and the medical equipment used. Then, it consults the medical fee database 790 to calculate the official prices corresponding to the identified medical practice etc., and adds up these official prices. Through this process, the medical fee for the single medical practice can be calculated. Then, the profit from the medical practice can be calculated by subtracting the costs of this medical practice, calculated by the foregoing equation 1, from the medical fee.

The display unit 84 displays the costs and profit for the single medical practice, calculated by the calculation unit 82. Incidentally, when the display unit 84 displays the calculations of the calculation unit 82, or the costs and the profit for the single medical practice, it may provide graphical representation so that the deviation therebetween can be seen easily. The display unit 84 may be a display of an external terminal connectable to the medical institution computer 22. For example, when the medical institution computer 22 is installed in a nurse station, a terminal installed in the director's office may be used for display.

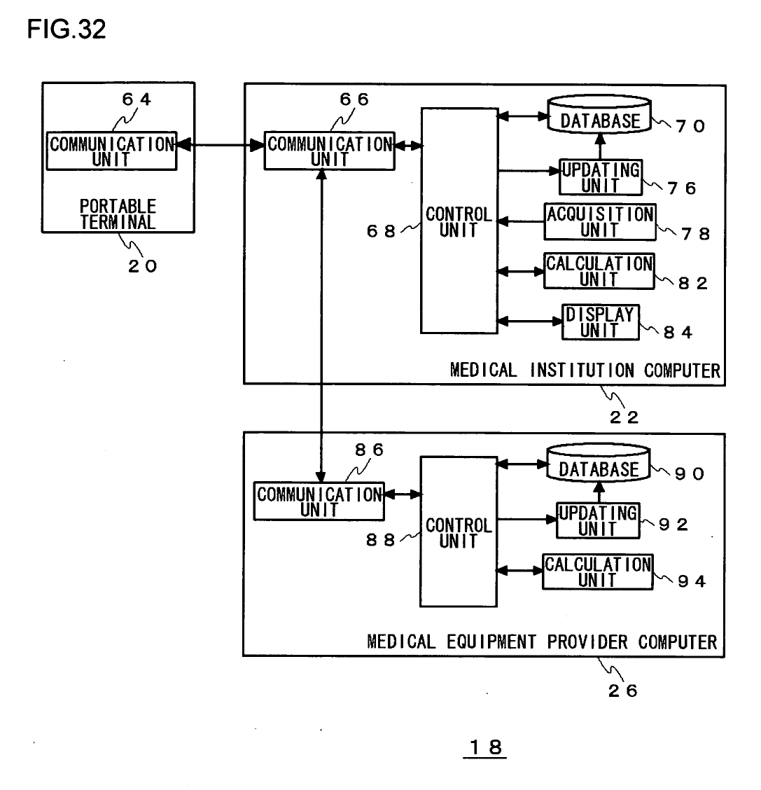

FIG. 32 is a diagram showing a second configuration of the medical practice management system 18 according to embodiment 2 of the present invention. The second configuration differs from the first configuration in that the medical institution computer 22 and a medical equipment provider computer 26 cooperate to manage the data for calculating costs for each single medical practice and calculate the costs.

The medical equipment provider computer 26 includes a communication unit 86, a control unit 88, a database 90, an updating unit 92, and a calculation unit 94. According to the second configuration, the plurality of databases 710 to 790 shown in FIG. 31 are distributed between the database 70 of the medical institution computer 22 and the database 90 of the medical equipment provider computer 26 for management. For example, the database 70 of the medical institution computer 22 manages the administrative information storage database 710 and the labor cost database 720. Then, the database 90 of the medical equipment provider computer 26 manages the medical equipment cost database 730 and the subsequent databases 740 to 790. The labor cost database 720 is characteristically difficult to put outside the medical institution since it contains personnel information. For this reason, the labor cost database 720 is managed in the database 70 of the medical institution computer 22.

Moreover, in this example, some of the data of the administrative information storage database 710 pertaining to information that is desirably kept inside the medical institution, such as information on medical practitioners and information on the time of administration of medical practices, may be managed in the database 70 of the medical institution computer 22. Then, the rest of the administrative information may be managed in the database 90 of the medical equipment provider computer 26.

Data that the medical institution prefers to keep inside, such as that of the maintenance and repair cost database 760 and the medical waste processing cost database 770, may also be managed in the database 70 of the medical institution computer 22. As above, the administrative information and the data for calculating the various costs may be distributed for management arbitrarily depending on the judgment of the medical institution. Now, the data managed in the database 70 of the medical institution computer 22 may be transmitted to the database 90 of the medical equipment provider computer 26 for the sake of synchronization. The control unit 68 transmits the data stored in the database 70 via the communication unit 66. The control unit 88 receives the data transmitted from the medical institution computer 22 via the communication unit 86, and stores it into the database 90. Incidentally, the synchronization is effected either by prompting a data-entry personnel for manual synchronization or by conducting automatic synchronization at predetermined timing. For manual synchronization, the control unit 68 may display the number of records of data to be transmitted and a transmission button on the display unit 84, so that the synchronization processing is performed when the transmission button is pressed. Incidentally, after the synchronization processing, transmission flags are set on the database 70 of the medical institution computer 22. When orders are changed and the contents of the database 70 are updated, the transmission flags on the corresponding data are reset so that the data is handled as data to be updated by the synchronization processing again. The history of the synchronization processing, such as transmission records, may also be kept for a predetermined period so that the history is shown in a list view when a request for checking the transmission information is issued.

In FIG. 32, the medical institution computer 22 and the medical equipment provider computer 26 both have the calculation units 82 and 94. In this respect, it is essential only that a calculation unit be provided at least in either one of the computers. In that case, the communication units 66 and 68 of the two computers 22 and 26 are used to transmit data to the computer that has the calculation unit. The computer then calculates the costs and profit for each single medical practice.

The calculation units 82 and 94 of both the computers 22 and 26 may only conduct calculation as far as possible with the data distributed to the respective databases 70 and 90. Then, the calculations of both the calculation units 82 and 94 may be collected to either one of the computers 22 and 26 by using the communication units 66 and 68, so that the costs and profit for each single medical practice are calculated eventually.

Next, description will be given of how to calculate the costs for a single medical practice when the medical instruments and medical equipment used in the medical practice include reusable products. Reusable products refer to ones that are supposed to be used a plurality of times. The examples thereof include medical instruments such as an endoscope, and medical equipment that can be reused after disinfection and sterilization. For disposable equipment other than the reusable products, the costs of the equipment in a single medical practice can be calculated simply by multiplying the unit prices of the equipment by the quantities used in the medical practice.

In contrast, the costs of the reusable products are calculated based on their monetary valuations for a single medical practice, not the unit prices. For example, a CPP (Cost Per Procedure) system is one in which medical instruments are charged for in accordance with the numbers of uses for medical inspection and treatment purposes. In this system, the monetary valuations for a single medical practice of use decrease with increasing numbers of uses. For example, if the threshold number of cases to change a monetary valuation is set at 100, the updating unit 76 of the medical institution computer 22 or the updating unit 92 of the medical equipment provider computer 26 may exercise the following processing. That is, when the number of cases stored in the administrative information storage database 710 exceeds 100, the monetary valuation of the reusable product for a single medical practice of use, managed in the medical equipment cost database 730, the medical instrument purchase cost database 740, and the like, is lowered.

The monetary valuation of a reusable product for a single medical practice of use may also be determined by various other methods. For example, the foregoing monetary valuation of a medical instrument may be determined by calculating the amount of annual depreciation thereof, and dividing the amount by the number of uses, or the estimated number of uses, of the instrument in that year. If the number of uses of a reusable product is determined by some rule or is empirically predictable, the unit price of the reusable product may be simply divided by the number of uses to determine the monetary valuation.

As far as the management of reusable products is concerned, the medical equipment cost database 730, the medical instrument purchase cost database 740, and the like manage the monetary valuations of the reusable products for a single medical practice of use, not the unit prices of the same. Then, at least either one of the calculation units 82 and 94 of the medical institution computer 22 and the medical equipment provider computer 26 can calculate the costs of each reusable product ascribable to a medical practice as follows: the monetary valuation of the reusable product for a single medical practice of use, multiplied by the quantity used in the medical practice.

Note that at least either one of the calculation units 82 and 94 of the two computers 22 and 26 also calculates the monetary valuations of the maintenance and repair costs, the medical waste processing costs, and the disinfection and sterilization costs for a single medical practice unless those costs are managed in the form of the unit prices for a single medical practice. Even in this case, various evaluation methods can be used as mentioned above.

Next, description will be given of the method for utilizing the data stored in the administrative information storage database 710 effectively. At least either one of the calculation units 82 and 94 of the medical institution computer 22 and the medical equipment provider computer 26 determines the labor costs, material costs, and the like for each single medical practice technique by technique or patient by patient. Then, the display unit 84 can display the determined numeric data. Here, the material costs may be displayed as the total cost of the medical instruments and medical equipment used in each medical practice, or as instrument-specific or equipment-specific costs.

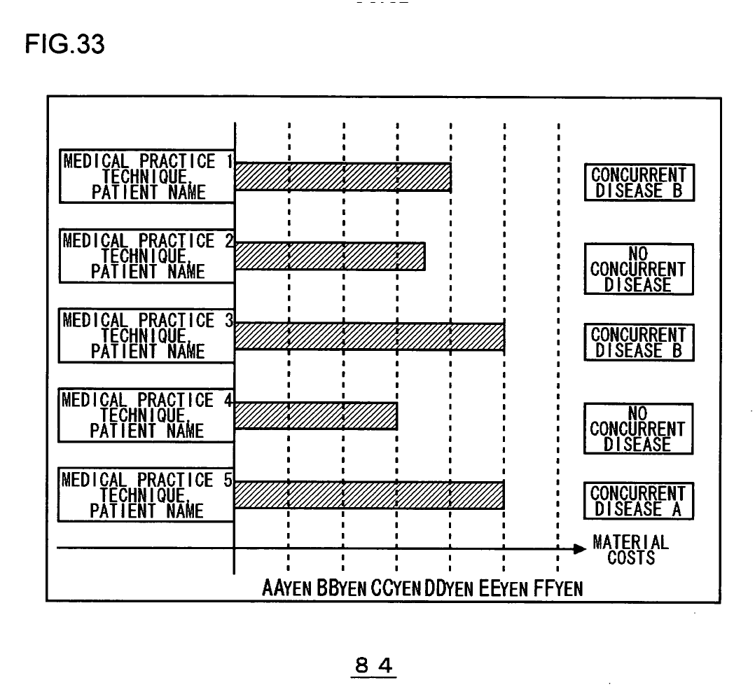

FIG. 33 shows a screen for showing the relation between the material costs and concurrent diseases graphically, which appears on the display unit 84. On this screen, the vertical axis indicates information for identifying individual medical practices, and the horizontal axis the amounts of the material costs. In the diagram, techniques and patient names are displayed as the information for identifying the individual medical practices. It is understood that the medical practices may be identified from such information as serial numbers given to the respective medical practices. The user can sort and display the medical practices by technique or by patient. Here, each medical practice is displayed in association with whether or not the target patient has any concurrent disease, and what case if any. Since the relation among the presence or absence of concurrent diseases, the case thereof, and the material costs is displayed distinctively, it is possible to recognize the relationship between the case pattern and the material costs easily. While the horizontal axis of FIG. 33 indicates the material costs, it may show user-selected cost items such as the labor costs. The operating time may be plotted on the horizontal axis.

In the above manner, graphical representation may also be given of the relation between the number of days of hospitalization of a patient and the operator who has administered a medical practice to that patient, the relation between the number of days of hospitalization of a patient and the time of the operation given to the patient, and so on. The database 70 of the medical institution computer 22 usually contains the numbers of days of hospitalization of patients, which can thus be utilized for that purpose.

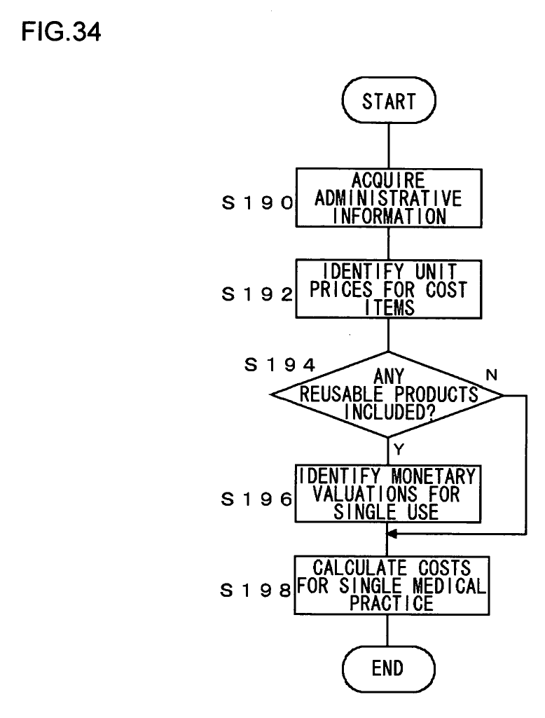

Description will now be given of the operation of the medical practice management system 18 which has the foregoing configuration according to embodiment 2. FIG. 34 is a flowchart showing the procedure by which the medical practice management system 18 calculates the costs for a single medical practice. The acquisition unit 78 acquires the administrative information on each medical practice (S190). At least either one of the calculation units 82 and 94 of the medical institution computer 22 and the medical equipment provider computer 26 identifies the medical practitioners involved in the medical practice, the medical equipment and medical instruments used, and so forth based on personnel and physical information included in the administrative information. Then, the calculation unit consults the databases 720 to 780, which contain various cost items and are managed in at least either one of the databases 70 and 90 of the medical institution computer 22 and the medical equipment provider computer 26. The calculation unit thereby identifies the hourly wages of the medical practitioners, the unit prices of the medical equipment, and so on (S192).

Here, if any reusable products are included in the administrative information (Y at S194), the monetary valuations of the reusable products for a single medical practice of use are determined with reference to the databases 720 to 780 which manage the various cost items (S196). If the monetary valuations vary depending on the condition at the point in time, the monetary valuations at that point are calculated. Then, the calculation unit 82 or 94 calculates the costs for the respective cost items, and sums up these to determine the costs for the single medical practice (S198).

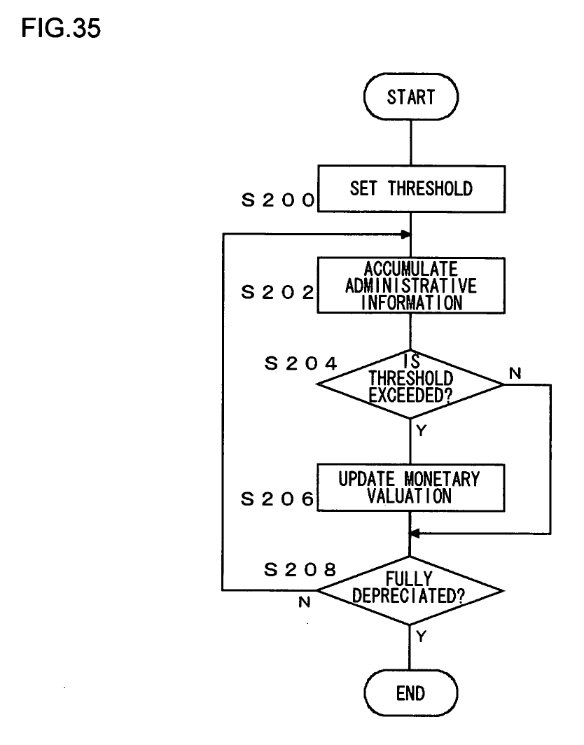

FIG. 35 is a flowchart showing the procedure by which the medical practice management system 18 updates the monetary valuations for reusable products. Initially, a threshold for changing the monetary valuation of a reusable product or the like for a single medical practice of use is set into at least either one of the updating units 76 and 92 of the medical institution computer 22 and the medical equipment provider computer 26 (S200). For example, the threshold is established by contract with the medical equipment provider. At least either one of the databases 70 and 90 of the medical institution computer 22 and the medical equipment provider computer 26 accumulates administrative information (S202). When the updating unit 76 or 92 detects that the number of uses of the reusable product exceeds the foregoing threshold (Y at S204), it changes the monetary valuation of the reusable product for a single medical practice of use (S206). For example, when the number of uses exceeds the threshold, the monetary valuation is lowered. This monetary valuation keeps being updated until the reusable product or the like is fully depreciated (Y at S208).

As has been described, according to embodiment 2, the costs and profit for each single medical practice can be calculated to analyze the profit-loss balance of the medical business in units of medical practices accurately. The costs for a single medical use are calculated with consideration also given to costs other than the labor costs and the medical material costs, i.e., those including the maintenance and repair costs, the disinfection and sterilization costs, and the medical waste processing costs. This allows yet detailed cost management. Since the medical equipment and medical instruments that will not be charged in units of medical practices, such as reusable products, are subjected to the monetary evaluation for each single medical practice of use, it is possible to exercise accurate cost management closer to the actual situations. Profit for a single medical practice can also be calculated accurately by using the medical fee database and the costs for each single medical practice.

Furthermore, a variety of display modes are available, including a graphical representation and a display for contrasting a certain cost item with the presence or absence of concurrent diseases and the cases thereof. This makes it possible to grasp the relation among the profit-loss balance of the medical business, certain phenomena, and certain cost items visually. These pieces of information can be utilized for future business judgment.

The invention described in embodiment 2 may be defined as follows:

One of the aspects of the present embodiment is a medical practice management system. This medical practice management system comprises: an acquisition unit which acquires administrative information on a medical practice to be administered, the administrative information including at least information on medical equipment to be used and information on a medical practitioner; a storing unit which stores unit prices for a plurality of respective cost items including a cost of the medical equipment and a labor cost of the medical practitioner; and a calculation unit which calculates costs for a single medical practice with reference to the administrative information and the unit prices. Here, “a single medical practice” may conceptually include a single intervention, or a single unit of surgical operation, and a single inspection.

According to this aspect, the costs for a single medical practice can be calculated for the sake of detailed cost management.

The storing unit may further store one or more of a medical instrument purchase cost, a medical instrument lease cost, a maintenance and repair cost, a medical waste processing cost, and a disinfection and sterilization cost as the cost items. This allows yet detailed cost management.

The calculation unit may calculates a valuation of a matter for a single medical practice of use and handle the valuation the same as a unit price thereof, the matter being used over a plurality of medical practices. In this case, it becomes possible to grasp the costs for each medical practice even closer to the actual situations.

The medical practice management system may further comprise an updating unit for updating the valuation in accordance with a predetermined condition. The “predetermined condition” may be the number of uses of that matter. In this case, costs can be calculated with consideration given to flexible modes of contract between the medical institution and the provider of the medical instrument etc.

The medical practice management system may further comprise a display unit for displaying a result of calculation of the calculation unit. Here, the storing unit stores the administrative information. The calculation unit determines the numeric data of a designated item concerning the medical practice administered, with reference to the storing unit. The display unit displays the numeric data. In this case, the costs for each medical practice and other items can be grasped visually.

The display unit may display the numeric data in the form of a graph in accordance with a designated classification method. In this case, information useful for business judgment, including the relation between a certain phenomenon and a certain cost item, can be grasped visually.

The storing unit may further store information on a medical fee. Then, the calculation unit further calculates a medical fee for a single medical practice with reference to the administrative information. In this case, the medical fees and profit for a single medical practice can be grasped accurately.

Still another aspect of the present embodiment is a management server. This management server comprises: an acquisition unit which acquires administrative information on a medical practice to be administered, the administrative information including at least information on medical equipment to be used and information on a medical practitioner; a storing unit which stores unit prices for a plurality of respective cost items including a cost of the medical equipment and a labor cost of the medical practitioner; and a calculation unit which calculates costs for a single medical practice with reference to the administrative information and the unit prices.

According to this aspect, the costs for a single medical practice can be calculated for the sake of detailed cost management.

Still another aspect of the present embodiment is a medical practice management method. This method comprises: acquiring administrative information on a medical practice to be administered, the administrative information including at least information on medical equipment to be used and information on a medical practitioner; and calculating costs for a single medical practice with reference to the administrative information and unit prices for a plurality of cost items including a cost of the medical equipment and a labor cost of the medical practitioner, the unit prices being stored in a memory.

According to this aspect, the costs for a single medical practice can be calculated for the sake of detailed cost management.

Up to this point, the present invention has been described in conjunction with the embodiments thereof. These embodiments have been given solely by way of illustration. It will be understood by those skilled in the art that various modifications may be made to combinations of the foregoing components and processes, and all such modifications are also intended to fall within the scope of the present invention.

In embodiment 1 of the present invention, the “technique” field of the schedule information stored or managed in the portable terminal 20 or the medical institution computer 22 is in association with the information on medical equipment. This is not restrictive, however. Instead, the “operator” field may be associated with the information on medical equipment. In other words, the information on medical equipment may be defined to vary depending on the “operator.” Moreover, a plurality of fields may also be associated with the information on medical equipment. Here, the database 70 also stores the labor costs for medical practitioners. Then, the selection unit 56 also selects a medical practitioner to administer a medical practice under an instruction from a medical practitioner. With reference to the database 70, the calculation unit 80 identifies the labor costs for the medical practitioner selected by the selection unit 56, and includes the identified labor costs into the costs of the medical practice going to be administered. According to such a modification, the pieces of medical equipment to be prepared can be adjusted depending on the medical practitioner. This allows finer settings. Besides, it is possible to clarify the costs including the labor costs. In summary, any field may be associated as long as the information on medical equipment depends thereon.

Embodiments 1 and 2 of the present invention have dealt with the cases where the medical practices are surgical operations. This is not restrictive, however. For example, medication and other practices are also applicable. According to this modification, the present invention can be applied to various medical practices. That is, any medical practices are applicable as long as information management is required, and where causes and operation details can be associated with each other as is the case with treatment to an identical disease.

In embodiment 1 of the present invention, the display unit 84 may be given the following configuration: That is, the display unit 84 may be configured to display the schedule information not only piece by piece, but also day by day, or even to switch between these display modes. The display unit 84 may also be configured so that it can switch display between schedule information whose administrative contents are yet to be entered and schedule information whose administrative contents are already entered. According to this modification, it is possible to improve the convenience of the medical practitioners.

In embodiment 1 of the present invention, the calculation unit 82 may divide the costs into labor costs and material costs for calculation. In embodiments 1 and 2 of the present invention, the calculation unit 82 may add up the costs by technique, by patient, or by operator. Moreover, the calculation unit 82 may perform statistical processing such as averaging. For example, it may calculate and display various indexes for hospital management, including the daily average number of outpatients and daily profit per inpatient. According to this modification, it is possible to acquire data available for business analysis.

Embodiments 1 and 2 of the present invention have dealt with the cases where the updating unit 76 simply reflects the difference between the information on medical equipment stored in the database 70 and the read identification numbers upon the information on medical equipment stored in the database 70. This is not restrictive, however. For example, the difference may be subjected to statistical or other processing before reflected upon the information on medical equipment stored in the database 70. According to this modification, it is possible to improve the accuracy of the information on medical equipment stored in the database 70. What is essential is only that the information on medical equipment stored in the database 70 approaches the medical equipment used actually.

In embodiment 2 of the present invention, the databases 720 to 780 for various types of cost items are constructed as shown in FIG. 32. In this respect, additional databases may also be constructed for hospital facility rents, utility bills, tax and dues, etc. In this case, it becomes even possible to calculate profit after fixed cost deduction, profit after overhead deduction, and profit after tax.

While the preferred embodiments of the present invention have been described using specific terms, such description is for illustrative purposes only, and it is to be understood that changes and variations may be made without departing from the spirit or scope of the appended claims.

What is claimed is:

1. A medical practice management system comprising:
an acquisition unit which acquires schedule information on a medical practice to be administered to a patient;
a storing unit which stores a plurality of pieces of information on medical equipment to be used in a medical practice, in association with a plurality of pieces of schedule information, respectively;
a selection unit which selects information on medical equipment corresponding to the schedule information acquired by the acquisition unit, from among the plurality of pieces of information on medical equipment stored in the storing unit; and
a management unit which manages the acquired schedule information and the information on medical equipment selected by the selection unit in association with each other.

2. The medical practice management system according to claim 1, further comprising
a display unit which displays a plurality of pieces of schedule information when the acquisition unit acquires schedule information, and wherein
the acquisition unit acquires the schedule information by having a medical practitioner select any one of the plurality of pieces of schedule information displayed on the display unit.

3. The medical practice management system according to claim 1, further comprising
an editing unit from which the medical practitioner edits at least either the schedule information or the information on medical equipment to be managed by the management unit.

4. The medical practice management system according to claim 1, wherein:
the schedule information acquired by the acquisition unit includes at least a name of a doctor to conduct the medical practice and a type of the medical practice;
the plurality of pieces of information on medical equipment stored in the storing unit are associated with the names of doctors to conduct medical practices and the types of the medical practices;
the selection unit selects information on medical equipment corresponding to the name of the doctor to conduct the medical practice and the type of the medical practice which are acquired by the acquisition unit; and
the management unit manages the acquired name of the doctor to conduct the medical practice, the type of the medical practice, and the information on medical equipment selected by the selection unit in association with one another.

5. The medical practice management system according to claim 1, wherein:
the schedule information acquired by the acquisition unit includes the types of a plurality of medical practices;
the selection unit selects a piece of information on medical equipment corresponding to the respective types of the plurality of medical practices acquired by the acquisition unit; and
the management unit manages the information on medical equipment selected by the selection unit collectively, regardless of the types of the plurality of medical practices acquired by the acquisition unit.

6. A medical practice management system comprising:
a storing unit which stores a plurality of combinations of schedule information on medical practices to be administered to patients and information on medical equipment to be used in the medical practices;
a selection unit which selects schedule information corresponding to a medical practice going to be administered, from among the plurality of combinations stored in the storing unit, under an instruction from a medical practitioner;
a reading unit which reads, from exterior, an identification code assigned to medical equipment to be used actually in the medical practice going to be administered; and
an updating unit which associates the information on medical equipment corresponding to the schedule information selected by the selection unit, out of the plurality of combinations stored in the storing unit, with the identification code read by the reading unit, and updates the combinations stored in the storing unit.

7. The medical practice management system according to claim 6, further comprising
a display unit which displays a plurality of pieces of schedule information stored in the storing unit when the selection unit selects schedule information, and wherein
the selection unit makes the medical practitioner select any one of the plurality of pieces of schedule information displayed on the display unit, thereby selecting the schedule information corresponding to the medical practice going to be administered.

8. The medical practice management system according to claim 6, wherein:
the identification code read by the reading unit includes information on quantity and an identification number; and
when the reading unit reads the identification code, the updating unit ignores the information on quantity and counts up the number of reads of the identification number in units of the identification number.

9. The medical practice management system according to claim 6, further comprising:
a modification unit which modifies the information on medical equipment corresponding to the schedule information selected by the selection unit; and
a display unit which displays the information on medical equipment upon which the modification made by the modification unit is reflected.

10. The medical practice management system according to claim 9, wherein
the updating unit updates the combinations stored in the storing unit so that the modification made by the modification unit is reflected thereon.

11. The medical practice management system according to claim 6, wherein
the storing unit stores costs of the medical equipment,
the medical practice management system further comprising
a calculation unit which identifies medical equipment based on the identification number read by the reading unit and adding up the cost of the medical equipment based on the identified medical equipment, with reference to the storing unit.

12. The medical practice management system according to claim 11, wherein:
the storing unit also stores labor costs of medical practitioners;
the selection unit also selects a medical practitioner to administer the medical practice under an instruction from a medical practitioner; and
the calculation unit identifies a labor cost for the medical practitioner selected by the selection unit and includes the identified labor cost into the costs of the medical practice going to be administered, with reference to the storing unit.

13. A medical practice management method comprising:
acquiring schedule information on a medical practice to be administered to a patient;
selecting information on medical equipment corresponding to the acquired schedule information, from among a plurality of pieces of information on medical equipment to be used in a medical practice, the plurality of pieces of information on medical equipment being stored in a memory in association with a plurality of pieces of schedule information, respectively; and
managing the acquired schedule information and the selected information on medical equipment in association with each other.

14. The medical practice management method according to claim 13, comprising:
selecting schedule information corresponding to a medical practice going to be administered, under an instruction from a medical practitioner, from among a plurality of combinations of schedule information on medical practices to be administered to patients and associated information on medical equipment to be used in the medical practices, the plurality of combinations being stored in the memory;
reading, from exterior, an identification number assigned to medical equipment to be used actually in the medical practice going to be administered; and
associating the information on medical equipment corresponding to the selected schedule information, out of the plurality of combinations stored in the memory, with the read identification, and updating the combinations stored in the memory.

15. The medical practice management method according to claim 13, comprising:
acquiring schedule information concerning a medical practice to be administered to a patient;
selecting information on medical equipment corresponding to the acquired schedule information, from among a plurality of pieces of information on medical equipment to be used in a medical practice, the plurality of pieces of information on medical equipment being stored in the memory in association with a plurality of pieces of schedule information, respectively;
reading, from exterior, an identification number assigned to medical equipment to be used actually in a medical practice corresponding to the selected information on medical equipment, the medical practice being going to be administered by a medical practitioner; and
updating the plurality of pieces of information on medical equipment stored in the memory based on a difference between the selected information on medical equipment and the read identification number.

16. The medical practice management method according to claim 13, comprising:
acquiring administrative information on a medical practice to be administered, the administrative information including at least information on medical equipment to be used and information on a medical practitioner; and
calculating costs for a single medical practice with reference to the administrative information and unit prices of a plurality of cost items including a cost of the medical equipment and a labor cost of the medical practitioner, the unit prices being stored in the memory.
